(19) United States
(12) Patent Application Publication
(10) Pub. No.: US 2026/0330406 A1
(43) Pub. Date: Oct. 22, 2026

(54) SYSTEMS, APPARATUSES, METHODS, AND COMPUTER PROGRAM PRODUCTS FOR REAL-TIME PROJECT INVENTORY OPTIMIZATION

(71) Applicant: Honeywell International Inc., Charlotte, NC (US)

(72) Inventors: Honey RAGHAVAN, Bangalore (IN); Anil PALLAYIL, Charlotte, NC (US); Rahul SHARMA, Houston, TX (US)

(21) Appl. No.: 19/650,537

(22) Filed: Apr. 17, 2026

Related U.S. Application Data
(60) Provisional application No. 63/790,882, filed on Apr. 18, 2025.

(51) Int. Cl. G06Q 10/087

(52) U.S. Cl. CPC G06Q 10/08726

(57) ABSTRACT

Systems, apparatuses, methods, and computer program products are provided herein. For example, a method may include accessing, at a project orchestration predictive computing entity, a project physical component record, retrieving, using an inventory predictive computing entity, a set of candidate external resource objects from an external resource object database based on the physical component object, extracting, using the inventory predictive computing entity, an external resource object from the set of candidate external resource objects by applying the physical component object and the set of candidate external resource objects to an external resource prediction model, generating, using the external resource prediction model, an external resource prediction for the external resource object based on an external resource feature associated with the external resource object, and performing, using the project orchestration predictive computing entity, one or more external resource implementation actions based on the external resource object.

### CROSS-REFERENCE TO RELATED APPLICATIONS

This nonprovisional application claims the benefit of priority to U.S. Provisional Patent Application No. 63/790,882, filed Apr.18, 2025, entitled “SYSTEMS, APPARATUSES, METHODS, AND COMPUTER PROGRAM PRODUCTS FOR REAL-TIME PROJECT INVENTORY OPTIMIZATION,” the entire contents of which are hereby incorporated by reference for all purposes pursuant to 35 U.S.C. § 119(e).

### TECHNOLOGICAL FIELD

Embodiments of the present disclosure relate generally to systems, apparatuses, methods, and computer program products for real-time project inventory optimization.

### BACKGROUND

Applicant has identified many technical challenges and difficulties associated with systems, apparatuses, methods, and computer program products for real-time project inventory optimization. Through applied effort, ingenuity, and innovation, Applicant has solved problems related to systems, apparatuses, methods, and computer program products for real-time project inventory optimization by developing solutions embodied in the present disclosure, which are described in detail below.

### BRIEF SUMMARY

Various embodiments described herein relate to systems, apparatuses, methods, and computer program products for real-time project inventory optimization.

In accordance with one aspect of the disclosure a method is provided. In some embodiments, the method comprises accessing, at a project orchestration predictive computing entity, a first project physical component record. In some embodiments, the first project physical component record comprises a physical component object. In some embodiments, the method comprises retrieving, using an inventory predictive computing entity, a set of candidate external resource objects from an external resource object database based on the physical component object. In some embodiments, the method comprises extracting, using the inventory predictive computing entity, a first external resource object from the set of candidate external resource objects by applying the physical component object and the set of candidate external resource objects to an external resource prediction model. In some embodiments, the method comprises generating, using the external resource prediction model, an external resource prediction for the first external resource object based on an external resource feature associated with the first external resource object. In some embodiments, the method comprises performing, using the project orchestration predictive computing entity, one or more external resource implementation actions based on the first external resource object.

In some embodiments, the method comprises identifying a project execution indication corresponding to the first project physical component record. In some embodiments, the method comprises training the external resource prediction model based on the project execution indication and the first external resource object.

In some embodiments, the method comprises generating, using the external resource prediction model, a project entity prediction for the first external resource object based on at least one of the external resource feature or a secondary physical component record.

In some embodiments, the method comprises generating an external resource implementation interface component. In some embodiments, the external resource implementation interface component comprises at least one of an external resource prediction representation or a physical component object representation. In some embodiments, the method comprises causing rendering of the external resource implementation interface component on an external resource implementation interface.

In some embodiments, the method comprises executing an external resource implementation computing script.

In some embodiments, the method comprises identifying an external resource impact event associated with the first external resource object. In some embodiments, the method comprises extracting an additional external resource object from the set of candidate external resource objects by applying the physical component object, the external resource impact event, and the set of candidate external resource objects to the external resource prediction model. In some embodiments, the method comprises generating, using the external resource prediction model, an additional external resource prediction for the additional external resource object based on an additional external resource feature associated with the additional external resource object. In some embodiments, the method comprises performing one or more external resource reconfiguration actions based on the additional external resource object.

In some embodiments, the method comprises generating, using the external resource prediction model, an additional project entity prediction for the additional external resource object based on the additional external resource feature and an additional physical component record.

In some embodiments, the method comprises executing an external resource impact event computing script to extract an external resource impact event indicator from an external event source.

In some embodiments, the method comprises generating an external resource reconfiguration interface component. In some embodiments, the external resource reconfiguration interface component comprises at least one of an additional external resource prediction representation or a physical component object representation. In some embodiments, the method comprises causing rendering of the external resource reconfiguration interface component on an external resource reconfiguration interface.

In some embodiments, the method comprises executing an external resource reconfiguration computing script.

In some embodiments, the external resource feature comprises one or more of an external resource configuration feature, an external resource generation feature, an external resource volume feature, and external resource temporal feature, an external resource geographic feature, or an external resource impact feature.

In accordance with another aspect of the disclosure, an apparatus is provided. In some embodiments, the apparatus includes memory and one or more processors communicatively coupled to the memory. In some embodiments, the one or more processors are configured to perform operations comprising accessing, at a project orchestration predictive computing entity, a first project physical component record. In some embodiments, the first project physical component record comprises a physical component object. In some embodiments, the one or more processors are configured to perform operations comprising retrieving, using an inventory predictive computing entity, a set of candidate external resource objects from an external resource object database based on the physical component object. In some embodiments, the one or more processors are configured to perform operations comprising extracting, using the inventory predictive computing entity, a first external resource object from the set of candidate external resource objects by applying the physical component object and the set of candidate external resource objects to an external resource prediction model. In some embodiments, the one or more processors are configured to perform operations comprising generating, using the external resource prediction model, an external resource prediction for the first external resource object based on an external resource feature associated with the first external resource object. In some embodiments, the one or more processors are configured to perform operations comprising performing, using the project orchestration predictive computing entity, one or more external resource implementation actions based on the first external resource object.

In some embodiments, the one or more processors are configured to perform operations comprising identifying a project execution indication corresponding to the first project physical component record. In some embodiments, the one or more processors are configured to perform operations comprising training the external resource prediction model based on the project execution indication and the first external resource object.

In some embodiments, the one or more processors are configured to perform operations comprising generating, using the external resource prediction model, a project entity prediction for the first external resource object based on at least one of the external resource feature or a secondary physical component record.

In some embodiments, the one or more processors are configured to perform operations comprising generating an external resource implementation interface component. In some embodiments, the external resource implementation interface component comprises at least one of an external resource prediction representation or a physical component object representation. In some embodiments, the one or more processors are configured to perform operations comprising causing rendering of the external resource implementation interface component on an external resource implementation interface.

In some embodiments, the one or more processors are configured to perform operations comprising executing an external resource implementation computing script.

In some embodiments, the one or more processors are configured to perform operations comprising identifying an external resource impact event associated with the first external resource object. In some embodiments, the one or more processors are configured to perform operations comprising extracting an additional external resource object from the set of candidate external resource objects by applying the physical component object, the external resource impact event, and the set of candidate external resource objects to the external resource prediction model. In some embodiments, the one or more processors are configured to perform operations comprising generating, using the external resource prediction model, an additional external resource prediction for the additional external resource object based on an additional external resource feature associated with the additional external resource object. In some embodiments, the one or more processors are configured to perform operations comprising performing one or more external resource reconfiguration actions based on the additional external resource object.

In some embodiments, the one or more processors are configured to perform operations comprising generating, using the external resource prediction model, an additional project entity prediction for the additional external resource object based on at least one of the additional external resource feature or an additional physical component record.

In some embodiments, the one or more processors are configured to perform operations comprising executing an external resource impact event computing script to extract an external resource impact event indicator from an external event source.

In some embodiments, the one or more processors are configured to perform operations comprising generating an external resource reconfiguration interface component. In some embodiments, the external resource reconfiguration interface component comprises at least one of an additional external resource prediction representation or a physical component object representation. In some embodiments, the one or more processors are configured to perform operations comprising causing rendering of the external resource reconfiguration interface component on an external resource reconfiguration interface.

In some embodiments, the one or more processors are configured to perform operations comprising executing an external resource reconfiguration computing script.

In some embodiments, the external resource feature comprises one or more of an external resource configuration feature, an external resource generation feature, an external resource volume feature, and external resource temporal feature, an external resource geographic feature, or an external resource impact feature.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for accessing, at a project orchestration predictive computing entity, a first project physical component record. In some embodiments, the first project physical component record comprises a physical component object. In some embodiments, the computer program code, in execution with at least one processor, configures the computer program product for retrieving, using an inventory predictive computing entity, a set of candidate external resource objects from an external resource object database based on the physical component object. In some embodiments, the computer program code, in execution with at least one processor, configures the computer program product for extracting, using the inventory predictive computing entity, a first external resource object from the set of candidate external resource objects by applying the physical component object and the set of candidate external resource objects to an external resource prediction model. In some embodiments, the computer program code, in execution with at least one processor, configures the computer program product for generating, using the external resource prediction model, an external resource prediction for the first external resource object based on an external resource feature associated with the first external resource object. In some embodiments, the computer program code, in execution with at least one processor, configures the computer program product for performing, using the project orchestration predictive computing entity, one or more external resource implementation actions based on the first external resource object.

In some embodiments, the computer program code, in execution with at least one processor, configures the computer program product for identifying a project execution indication corresponding to the first project physical component record. In some embodiments, the computer program code, in execution with at least one processor, configures the computer program product for training the external resource prediction model based on the project execution indication and the first external resource object.

In some embodiments, the computer program code, in execution with at least one processor, configures the computer program product for generating, using the external resource prediction model, a project entity prediction for the first external resource object based on at least one of the external resource feature or a secondary physical component record.

In some embodiments, the computer program code, in execution with at least one processor, configures the computer program product for generating an external resource implementation interface component. In some embodiments, the external resource implementation interface component comprises at least one of an external resource prediction representation or a physical component object representation. In some embodiments, the computer program code, in execution with at least one processor, configures the computer program product for causing rendering of the external resource implementation interface component on an external resource implementation interface.

In some embodiments, the computer program code, in execution with at least one processor, configures the computer program product for executing an external resource implementation computing script.

In some embodiments, the computer program code, in execution with at least one processor, configures the computer program product for identifying an external resource impact event associated with the first external resource object. In some embodiments, the computer program code, in execution with at least one processor, configures the computer program product for extracting an additional external resource object from the set of candidate external resource objects by applying the physical component object, the external resource impact event, and the set of candidate external resource objects to the external resource prediction model. In some embodiments, the computer program code, in execution with at least one processor, configures the computer program product for generating, using the external resource prediction model, an additional external resource prediction for the additional external resource object based on an additional external resource feature associated with the additional external resource object. In some embodiments, the computer program code, in execution with at least one processor, configures the computer program product for performing one or more external resource reconfiguration actions based on the additional external resource object.

In some embodiments, the computer program code, in execution with at least one processor, configures the computer program product for generating, using the external resource prediction model, an additional project entity prediction for the additional external resource object based on at least one of the additional external resource feature or an additional physical component record.

In some embodiments, the computer program code, in execution with at least one processor, configures the computer program product for executing an external resource impact event computing script to extract an external resource impact event indicator from an external event source.

In some embodiments, the computer program code, in execution with at least one processor, configures the computer program product for generating an external resource reconfiguration interface component. In some embodiments, the external resource reconfiguration interface component comprises at least one of an additional external resource prediction representation or a physical component object representation. In some embodiments, the computer program code, in execution with at least one processor, configures the computer program product for causing rendering of the external resource reconfiguration interface component on an external resource reconfiguration interface.

In some embodiments, the computer program code, in execution with at least one processor, configures the computer program product for executing an external resource reconfiguration computing script.

In some embodiments, the external resource feature comprises one or more of an external resource configuration feature, an external resource generation feature, an external resource volume feature, and external resource temporal feature, an external resource geographic feature, or an external resource impact feature.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of the environment in which embodiments of the present disclosure may operate;

FIG. 3 illustrates an example block diagram of an example apparatus that may be specially configured in accordance with an example embodiment of the present disclosure;

FIG. 4 illustrates an example interface in accordance with an example embodiment of the present disclosure;

FIG. 5 illustrates an example interface in accordance with an example embodiment of the present disclosure;

FIG. 6 illustrates an example interface in accordance with an example embodiment of the present disclosure;

FIG. 7 illustrates a flowchart of an example method in accordance with one or more embodiments of the present disclosure;

FIG. 8 illustrates a flowchart of an example method in accordance with one or more embodiments of the present disclosure;

FIG. 9 illustrates a flowchart of an example method in accordance with one or more embodiments of the present disclosure;

FIG. 10 illustrates a flowchart of an example method in accordance with one or more embodiments of the present disclosure; and

FIG. 11 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with systems, apparatuses, methods, and computer program products for real-time project inventory optimization. As would be understood by one skilled in the field to which this disclosure pertains, there are numerous example scenarios in which systems, apparatuses, methods, and computer program products for real-time project inventory optimization are needed. For example, it may be desirable to use systems, apparatuses, methods, and computer program products for real-time project inventory optimization to generate an external resource prediction for an external resource object and identify an external resource impact event associated with the external resource object to optimally adapt to sudden occurrences impacting a project’s inventory.

Example solutions for real-time project inventory optimization include using computing devices to implement real-time project inventory optimization. However, such example solutions are simplistic, inefficient, and reactive. For example, such example solutions are simplistic because such example solutions do not implement a plurality of predictive computing entities to execute discrete tasks using generative artificial intelligence to implement real-time project inventory optimization. As another example, such example solutions are inefficient because such example solutions do not leverage an external resource prediction model for generating external resource predictions and entity predictions for real-time project inventory optimization. As another example, such example solutions are reactive because such example solutions do not automatically implement external resource implementation actions based on external resource objects. Accordingly, there is a need for systems, apparatuses, methods, and computer program products that perform real-time project inventory optimization in a sophisticated, efficient, and proactive manner.

Thus, to address these and/or other issues related to such example solutions, example systems, apparatuses, methods, and computer program products for real-time project inventory optimization are disclosed herein. For example, an embodiment in this disclosure, described in greater detail below, includes a method that includes accessing, at a project orchestration predictive computing entity, a first project physical component record. In some embodiments, the first project physical component record comprises a physical component object. In some embodiments, the method comprises retrieving, using an inventory predictive computing entity, a set of candidate external resource objects from an external resource object database based on the physical component object. In some embodiments, the method comprises extracting, using the inventory predictive computing entity, a first external resource object from the set of candidate external resource objects by applying the physical component object and the set of candidate external resource objects to an external resource prediction model. In some embodiments, the method comprises generating, using the external resource prediction model, an external resource prediction for the first external resource object based on an external resource feature associated with the first external resource object. In some embodiments, the method comprises performing, using the project orchestration predictive computing entity, one or more external resource implementation actions based on the first external resource object.

Further embodiments and advantages of the example systems, apparatuses, methods, and computer program products disclosed herein are described in the following co-pending U.S. patent applications: U.S. Application No. 63/790,880, titled “SYSTEMS, APPARATUSES, METHODS, AND COMPUTER PROGRAM PRODUCTS FOR AUTOMATED PROJECT OPERATIONS ARCHITECTURE”; U.S. Application No. 63/790,876, titled “SYSTEMS, APPARATUSES, METHODS, AND COMPUTER PROGRAM PRODUCTS FOR AN INTERACTIVE PROJECT REQUIREMENTS ANALYSIS ENGINE”; U.S. Application No. 63/790,873, titled “SYSTEMS, APPARATUSES, METHODS, AND COMPUTER PROGRAM PRODUCTS FOR A PROJECT OUTCOME PREDICTIVE ENGINE”; U.S. Application No. 63/790,878, titled “SYSTEMS, APPARATUSES, METHODS, AND COMPUTER PROGRAM PRODUCTS FOR NEW PROJECT GENERATION”; U.S. Application No. 63/790,875, titled “SYSTEMS, APPARATUSES, METHODS, AND COMPUTER PROGRAM PRODUCTS FOR GENERATING A NEW PHYSICAL COMPONENT”; U.S. Application No. 63/790,885, titled “SYSTEMS, APPARATUSES, METHODS, AND COMPUTER PROGRAM PRODUCTS FOR REAL-TIME PROJECT SERVICES OPERATIONS”; U.S. Application No. 63/790,889, titled “SYSTEMS, APPARATUSES, METHODS, AND COMPUTER PROGRAM PRODUCTS FOR PROJECT PROGRAM GENERATION”; U.S. Application No. 63/790,892, titled “SYSTEMS, APPARATUSES, METHODS, AND COMPUTER PROGRAM PRODUCTS FOR AUTOMATED PROJECT QUALITY CONTROL”; U.S. Application No. 63/790,879, titled “SYSTEMS, APPARATUSES, METHODS, AND COMPUTER PROGRAM PRODUCTS FOR AI DRIVEN PROJECT COMPLIANCE FORECASTING”, each of which is filed concurrently with the present application. The contents of each of the foregoing applications are hereby incorporated by reference in their entirety

### Example Systems and Apparatuses

Embodiments of the present disclosure herein include systems, apparatuses, methods, and computer program products configured for real-time project inventory optimization. It should be readily appreciated that the embodiments of the apparatus, systems, methods, and computer program product described herein may be configured in various additional and alternative manners in addition to those expressly described herein.

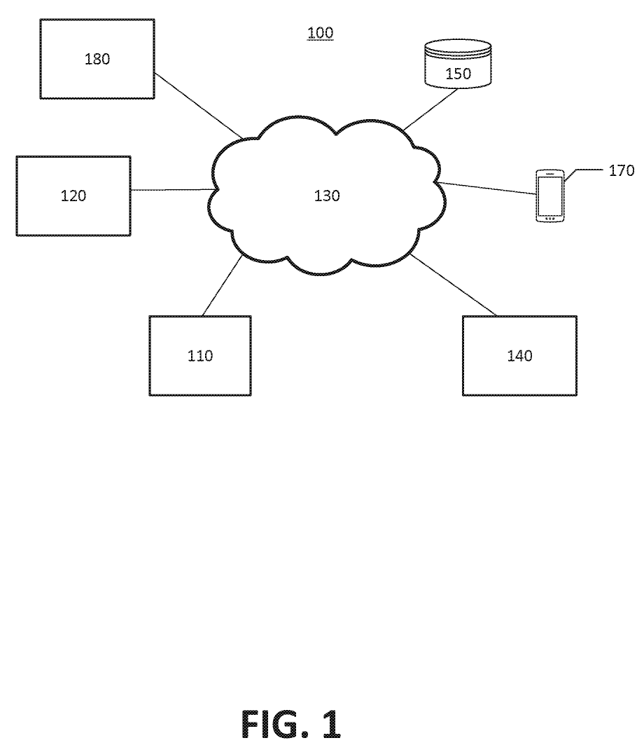

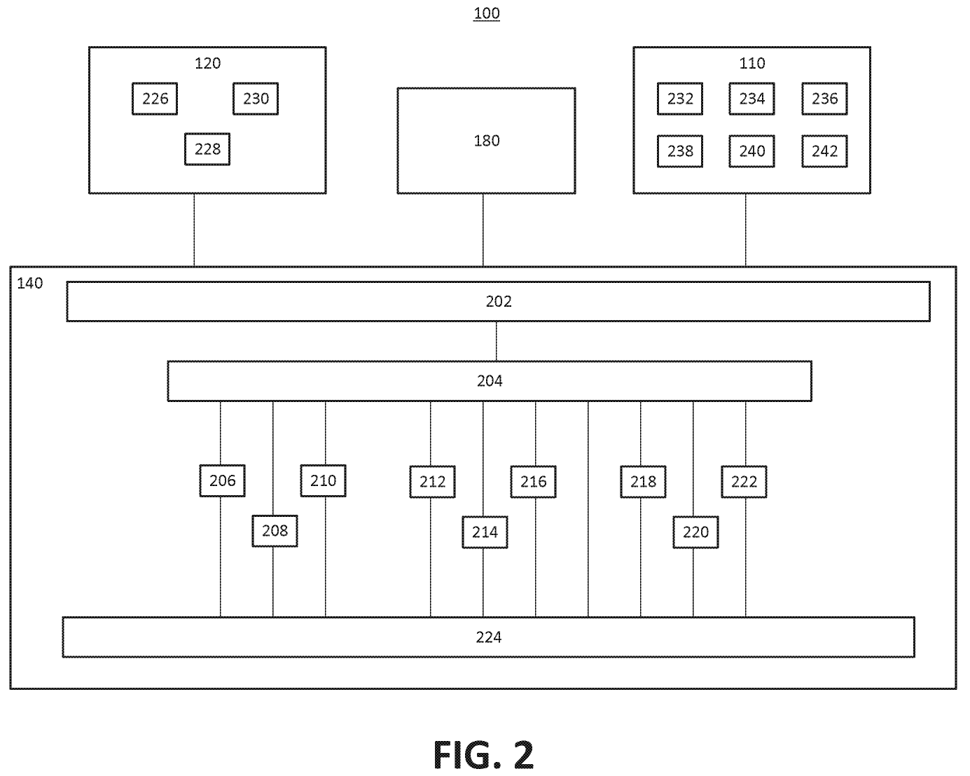

FIGS. 1 and 2 illustrate exemplary block diagrams of an environment 100 in which embodiments of the present disclosure may operate. In some embodiments, the environment 100 comprises a cloud-based project operations device 140. In some embodiments, the cloud-based project operations device 140 is electronically and/or communicatively coupled to a project foundation device 180, an external project implementation device 120, an external project application device 110, one or more databases 150, and/or the user device 170. The cloud-based project operations device 140 may be located remotely from the project foundation device 180, the external project implementation device 120, the external project application device 110, the one or more databases 150, and/or the user device 170. In this regard, for example, the cloud-based project operations device 140 may be located in a remote cloud server and electronically and/or communicatively coupled to the project foundation device 180, the external project implementation device 120, the external project application device 110, the one or more databases 150, and/or the user device 170 via at least the network 130. In some embodiments, the cloud-based project operations device 140 is configured via hardware, software, firmware, and/or a combination thereof, to perform data intake of one or more types of data.

Additionally, or alternatively, in some embodiments, the cloud-based project operations device 140 is configured via hardware, software, firmware, and/or a combination thereof, to generate and/or transmit command(s) that control, adjust, or otherwise impact operations of one or more of the project foundation device 180, the external project implementation device 120, the external project application device 110, the one or more databases 150, and/or the user device 170. Additionally, or alternatively, in some embodiments, the cloud-based project operations device 140 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the external project application device 110, the one or more databases 150, and/or the user device 170. For example, in various embodiments, the cloud-based project operations device 140 may be configured to execute and/or perform one or more operations and/or functions described herein.

In some embodiments, the cloud-based project operations device 140 comprises a project operations security layer 202 configured to execute and/or perform one or more operations and/or functions described herein. For example, the project operations security layer 202 may be configured to control access permissions for the cloud-based project operations device 140. In some embodiments, the cloud-based project operations device 140 comprises a project orchestration predictive computing entity 204 configured to execute and/or perform one or more operations and/or functions described herein. In some embodiments, the cloud-based project operations device 140 comprises one or more internal predictive computing entities configured to execute and/or perform one or more operations and/or functions described herein. For example, the cloud-based project operations device 140 may comprise an inventory predictive computing entity 206, a program predictive computing entity 208, a project condition predictive computing entity 210, a project record predictive computing entity 212, a project component engineering predictive computing entity 214, a project command predictive computing entity 216, a project prompt predictive computing entity 218, a project operations predictive computing entity 220, a project services predictive computing entity 222, and/or the like. In some embodiments, the cloud-based project operations device 140 comprises an internal database 224 configured to execute and/or perform one or more operations and/or functions described herein. For example, the internal database 224 may be a vectorized database.

In some embodiments, the environment 100 comprises the external project implementation device 120. In some embodiments, the external project implementation device 120 is electronically and/or communicatively coupled to the project foundation device 180, the external project application device 110, the cloud-based project operations device 140, the one or more databases 150, and/or the user device 170. The external project implementation device 120 may be located remotely from the project foundation device 180, the external project application device 110, the cloud-based project operations device 140, the one or more databases 150, and/or the user device 170. In this regard, for example, the external project implementation device 120 may be located in a remote cloud server and electronically and/or communicatively coupled to the project foundation device 180, the external project application device 110, the cloud-based project operations device 140, the one or more databases 150, and/or the user device 170 via at least the network 130. In some embodiments, the external project implementation device 120 is configured via hardware, software, firmware, and/or a combination thereof, to perform data intake of one or more types of data.

Additionally, or alternatively, in some embodiments, the external project implementation device 120 is configured via hardware, software, firmware, and/or a combination thereof, to generate and/or transmit command(s) that control, adjust, or otherwise impact operations of one or more of the project foundation device 180, the external project application device 110, the cloud-based project operations device 140, the one or more databases 150, and/or the user device 170. Additionally, or alternatively, in some embodiments, the external project implementation device 120 is configured via hardware, software, firmware, and/or a combination thereof, to perform data reporting, provide data, and/or other data output process(es) associated with monitoring or otherwise analyzing operations of one or more of the project foundation device 180, the external project application device 110, the cloud-based project operations device 140, the one or more databases 150, and/or the user device 170. For example, in various embodiments, the external project implementation device 120 may be configured to execute and/or perform one or more operations and/or functions described herein.

In some embodiments, the external project implementation device 120 comprises one or more external predictive computing entities configured to execute and/or perform one or more operations and/or functions described herein. For example, the external project implementation device 120 may comprise a project extraction predictive computing entity 226, a project code predictive computing entity 228, a project bot predictive computing entity 230, and/or the like.

In some embodiments, the environment 100 comprises an external project application device 110. In some embodiments, the external project application device 110 is electronically and/or communicatively coupled to the project foundation device 180, the external project implementation device 120, the cloud-based project operations device 140, the one or more databases 150, and/or the user device 170. The external project application device 110 may be located remotely from the project foundation device 180, the external project implementation device 120, the cloud-based project operations device 140, the one or more databases 150, and/or the user device 170. In this regard, for example, the external project application device 110 may be located in a remote cloud server and electronically and/or communicatively coupled to the project foundation device 180, the external project implementation device 120, the cloud-based project operations device 140, the one or more databases 150, and/or the user device 170 via at least the network 130. In some embodiments, the external project application device 110 is configured via hardware, software, firmware, and/or a combination thereof, to perform data intake of one or more types of data.

Additionally, or alternatively, in some embodiments, the external project application device 110 is configured via hardware, software, firmware, and/or a combination thereof, to generate and/or transmit command(s) that control, adjust, or otherwise impact operations of one or more of the project foundation device 180, the external project implementation device 120, the cloud-based project operations device 140, the one or more databases 150, and/or the user device 170. Additionally, or alternatively, in some embodiments, the external project application device 110 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the cloud-based project operations device 140, the one or more databases 150, and/or the user device 170. For example, in various embodiments, the external project application device 110 may be configured to execute and/or perform one or more operations and/or functions described herein.

In some embodiments, the external project application device 110 comprises one or more external computing applications configured to execute and/or perform one or more operations and/or functions described herein. For example, THE external project application device 110 may comprise a project operations computing application 232, a project impact value computing application 234, a project documentation computing application 236, a project component computing application 238, a project generation computing application 240, a project automation computing application 242, and/or the like.

In some embodiments, the environment 100 comprises the project foundation device 180. In some embodiments, the project foundation device 180 is electronically and/or communicatively coupled to the external project implementation device 120, the external project application device 110, the cloud-based project operations device 140, the one or more databases 150, and/or the user device 170. The project foundation device 180 may be located remotely from the external project implementation device 120, the external project application device 110, the cloud-based project operations device 140, the one or more databases 150, and/or the user device 170. In this regard, for example, the project foundation device 180 may be located in a remote cloud server and electronically and/or communicatively coupled to the external project implementation device 120, the external project application device 110, the cloud-based project operations device 140, the one or more databases 150, and/or the user device 170 via at least the network 130. In some embodiments, the project foundation device 180 is configured via hardware, software, firmware, and/or a combination thereof, to perform data intake of one or more types of data.

Additionally, or alternatively, in some embodiments, the project foundation device 180 is configured via hardware, software, firmware, and/or a combination thereof, to generate and/or transmit command(s) that control, adjust, or otherwise impact operations of one or more of the external project implementation device 120, the external project application device 110, the cloud-based project operations device 140, the one or more databases 150, and/or the user device 170. Additionally, or alternatively, in some embodiments, the project foundation device 180 is configured via hardware, software, firmware, and/or a combination thereof, to perform data reporting, provide data, and/or other data output process(es) associated with monitoring or otherwise analyzing operations of one or more of the external project implementation device 120, the external project application device 110, the cloud-based project operations device 140, the one or more databases 150, and/or the user device 170. For example, in various embodiments, the project foundation device 180 may be configured to execute and/or perform one or more operations and/or functions described herein.

The one or more databases 150 may be configured to receive, store, and/or transmit data. In some embodiments, the one or more databases 150 may be associated with data associated with the project foundation device 180, the external project implementation device 120, the external project application device 110, the cloud-based project operations device 140, and/or the user device 170. In some embodiments, the data may be received from the project foundation device 180, the external project implementation device 120, the external project application device 110, the cloud-based project operations device 140, and/or the user device 170. In some embodiments, the one or more databases 150 may be associated with data received from the project foundation device 180, the external project implementation device 120, the external project application device 110, the cloud-based project operations device 140, and/or the user device 170 in real-time. Additionally, or alternatively, the one or more databases 150 may be associated with data received from the project foundation device 180, the external project implementation device 120, the external project application device 110, the cloud-based project operations device 140, and/or the user device 170 on a periodic basis (e.g., the data may be received from the project foundation device 180, the external project implementation device 120, the external project application device 110, the cloud-based project operations device 140, the one or more databases 150, and/or the user device 170 once per day). Additionally, or alternatively, the one or more databases 150 may be associated with data received from the project foundation device 180, the external project implementation device 120, the external project application device 110, the cloud-based project operations device 140, and/or the user device 170 in response to a request for the data. Additionally, or alternatively, the one or more databases 150 may be associated with data inputted (e.g., by a user) into the project foundation device 180, the external project implementation device 120, the external project application device 110, the cloud-based project operations device 140, and/or the user device 170.

The user device 170 may be associated with users of the project foundation device 180, the external project implementation device 120, the external project application device 110, the cloud-based project operations device 140, and/or the one or more databases 150. In various embodiments, the project foundation device 180, the external project implementation device 120, the external project application device 110, the cloud-based project operations device 140, and/or the one or more databases 150 may generate and/or transmit a message, alert, or indication to a user via a user device 170. Additionally, or alternatively, a user device 170 may be utilized by a user to remotely access the project foundation device 180, the external project implementation device 120, the external project application device 110, the cloud-based project operations device 140, and/or the one or more databases 150. This may be by, for example, an application operating on the user device 170. A user may access the project foundation device 180, the external project implementation device 120, the external project application device 110, the cloud-based project operations device 140, and/or the one or more databases 150, remotely, including one or more visualizations, reports, and/or real-time displays.

In some embodiments, the project foundation device 180, the external project implementation device 120, the external project application device 110, the cloud-based project operations device 140, the one or more databases 150, and/or the user device 170 is associated with a determinable location. In some embodiments, the determinable location of the project foundation device 180, the external project implementation device 120, the external project application device 110, the cloud-based project operations device 140, the one or more databases 150, and/or the user device 170 represents an absolute position (e.g., GPS coordinates, latitude, and longitude locations, and/or the like) and/or a relative position (e.g., a point representation of the location of the project foundation device 180, the external project implementation device 120, the external project application device 110, the cloud-based project operations device 140, the one or more databases 150, and/or the user device 170 from a local origin point). In some embodiments, the project foundation device 180, the external project implementation device 120, the external project application device 110, the cloud-based project operations device 140, the one or more databases 150, and/or the user device 170 includes or otherwise is associated with a location sensor and/or software-driven location services that provide the location data representing the location corresponding to that the project foundation device 180, the external project implementation device 120, the external project application device 110, the cloud-based project operations device 140, the one or more databases 150, and/or the user device 170. In other embodiments the location of the project foundation device 180, the external project implementation device 120, the external project application device 110, the cloud-based project operations device 140, the one or more databases 150, and/or the user device 170 is stored and/or otherwise predetermined within a software environment, provided by a user and/or otherwise determinable to one or more systems.

Additionally, while FIGS. 1 and 2 illustrate certain components as separate, standalone entities communicating over the network 130, various embodiments are not limited to this configuration. In other embodiments, one or more components may be directly connected and/or share hardware or the like.

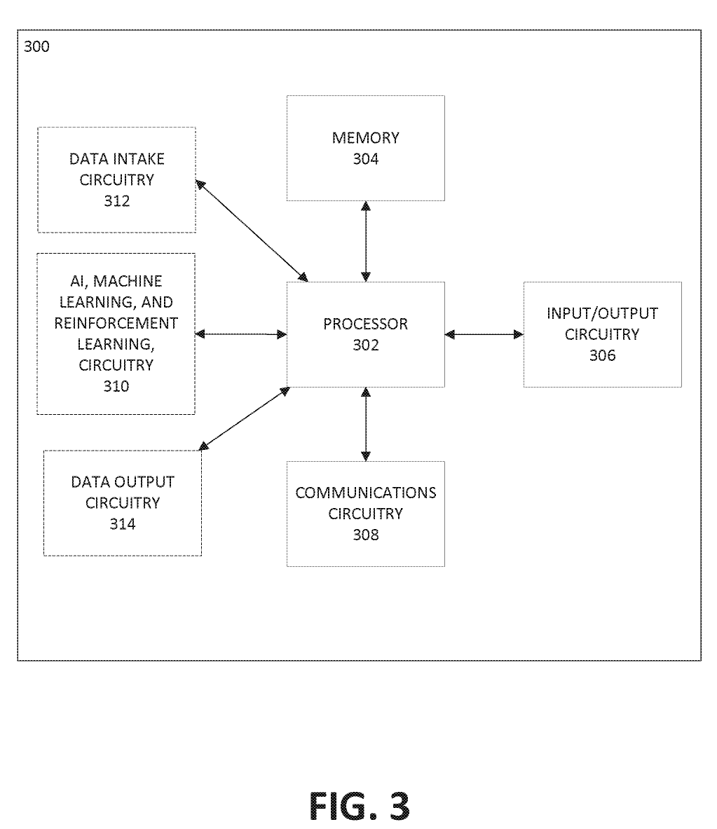

FIG. 3 illustrates an exemplary block diagram of an example apparatus that may be specially configured in accordance with an example embodiment of the present disclosure. Specifically, FIG. 3 depicts an example computing apparatus 300 (“apparatus 300”) specially configured in accordance with at least some example embodiments of the present disclosure. For example, the computing apparatus 300 may be embodied as one or more of a specifically configured personal computing apparatus, a specifically configured cloud-based computing apparatus, a specifically configured embedded computing device (e.g., configured for edge computing, and/or the like). Examples of an apparatus 300 may include, but is not limited to, the project foundation device 180, the external project implementation device 120, the external project application device 110, the cloud-based project operations device 140, the one or more databases 150, and/or the user device 170. The apparatus 300 includes processor 302, memory 304, input/output circuitry 306, communications circuitry 308, and/or optional artificial intelligence (“AI”) and machine learning circuitry 310. In some embodiments, the apparatus 300 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 300 of the project foundation device 180, the external project implementation device 120, the external project application device 110, the cloud-based project operations device 140, the one or more databases 150, and/or the user device 170 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 300 embodies a particular, specially configured computing entity transformed to enable the specific operations described herein and provide the specific advantages associated therewith, as described herein.

Processor 302 or processor circuity 302 may be embodied in a number of different ways. In various embodiments, the use of the terms “processor” should be understood to include a single core processor, a multi-core processor, multiple processors internal to the apparatus 300, and/or one or more remote or “cloud” processor(s) external to the apparatus 300. In some example embodiments, processor 302 may include one or more processing devices configured to perform independently. Alternatively, or additionally, processor 302 may include one or more processor(s) configured in tandem via a bus to enable independent execution of operations, instructions, pipelining, and/or multithreading.

In an example embodiment, the processor 302 may be configured to execute instructions stored in the memory 304 or otherwise accessible to the processor. Alternatively, or additionally, the processor 302 may be configured to execute hard-coded functionality. As such, whether configured by hardware or software methods, or by a combination thereof, processor 302 may represent an entity (e.g., physically embodied in circuitry) capable of performing operations according to embodiments of the present disclosure while configured accordingly. Alternatively, or additionally, processor 302 may be embodied as an executor of software instructions, and the instructions may specifically configure the processor 302 to perform the various algorithms embodied in one or more operations described herein when such instructions are executed. In some embodiments, the processor 302 includes hardware, software, firmware, and/or a combination thereof that performs one or more operations described herein.

In some embodiments, the processor 302 (and/or co-processor or any other processing circuitry assisting or otherwise associated with the processor) is/are in communication with the memory 304 via a bus for passing information among components of the apparatus 300.

Memory 304 or memory circuitry 304 may be non-transitory and may include, for example, one or more volatile and/or non-volatile memories. In some embodiments, the memory 304 includes or embodies an electronic storage device (e.g., a computer readable storage medium). In some embodiments, the memory 304 is configured to store information, data, content, applications, instructions, or the like, for enabling an apparatus 300 to carry out various operations and/or functions in accordance with example embodiments of the present disclosure.

Input/output circuitry 306 may be included in the apparatus 300. In some embodiments, input/output circuitry 306 may provide output to the user and/or receive input from a user. The input/output circuitry 306 may be in communication with the processor 302 to provide such functionality. The input/output circuitry 306 may comprise one or more user interface(s). In some embodiments, a user interface may include a display that comprises the interface(s) rendered as a web user interface, an application user interface, a user device, a backend system, or the like. In some embodiments, the input/output circuitry 306 also includes a keyboard, a mouse, a joystick, a touch screen, touch areas, soft keys a microphone, a speaker, or other input/output mechanisms. The processor 302 and/or input/output circuitry 306 comprising the processor may be configured to control one or more operations and/or functions of one or more user interface elements through computer program instructions (e.g., software and/or firmware) stored on a memory accessible to the processor (e.g., memory 304, and/or the like). In some embodiments, the input/output circuitry 306 includes or utilizes a user-facing application to provide input/output functionality to a computing device and/or other display associated with a user.

Communications circuitry 308 may be included in the apparatus 300. The communications circuitry 308 may include any means such as a device or circuitry embodied in either hardware or a combination of hardware and software that is configured to receive and/or transmit data from/to a network and/or any other device, circuitry, or module in communication with the apparatus 300. In some embodiments the communications circuitry 308 includes, for example, a network interface for enabling communications with a wired or wireless communications network. Additionally, or alternatively, the communications circuitry 308 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 308 may include circuitry for interacting with an antenna(s) and/or other hardware or software to cause transmission of signals via the antenna(s) and/or to handle receipt of signals received via the antenna(s). In some embodiments, the communications circuitry 308 enables transmission to and/or receipt of data from a user device, one or more sensors, and/or other external computing device(s) in communication with the apparatus 300.

Data intake circuitry 312 may be included in the apparatus 300. The data intake circuitry 312 may include hardware, software, firmware, and/or a combination thereof, designed and/or configured to capture, receive, request, and/or otherwise gather data associated with operations of the project foundation device 180, the external project implementation device 120, the external project application device 110, the cloud-based project operations device 140, the one or more databases 150, and/or the user device 170. In some embodiments, the data intake circuitry 312 includes hardware, software, firmware, and/or a combination thereof, that communicates with one or more sensor(s) unit(s), and/or the like within the project foundation device 180, the external project implementation device 120, the external project application device 110, the cloud-based project operations device 140, the one or more databases 150, and/or the user device 170 to receive particular data. Additionally, or alternatively, in some embodiments, the data intake circuitry 312 includes hardware, software, firmware, and/or a combination thereof, that retrieves particular data associated with the project foundation device 180, the external project implementation device 120, the external project application device 110, the cloud-based project operations device 140, the one or more databases 150, and/or the user device 170 from one or more data repository/repositories accessible to the apparatus 300.

AI and machine learning circuitry 310 may be included in the apparatus 300. The AI and machine learning circuitry 310 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 310 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 310 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 310 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 314 may be included in the apparatus 300. The data output circuitry 314 may include hardware, software, firmware, and/or a combination thereof, that configures and/or generates an output based at least in part on data processed by the apparatus 300. In some embodiments, the data output circuitry 314 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 314 includes hardware, software, firmware, and/or a combination thereof, that configures a particular output data object, output data file, and/or user interface for storing, transmitting, and/or displaying. For example, in some embodiments, the data output circuitry 314 generates and/or specially configures a particular data output for transmission to another system sub-system for further processing. Additionally, or alternatively, in some embodiments, the data output circuitry 314 includes hardware, software, firmware, and/or a combination thereof, that causes rendering of a specially configured user interface based at least in part on data received by and/or processing by the apparatus 300.

In some embodiments, two or more of the sets of circuitries 302-314 are combinable. Alternatively, or additionally, one or more of the sets of circuitry 302-314 perform some or all of the operations and/or functionality described herein as being associated with another circuitry. In some embodiments, two or more of the sets of circuitry 302-314 are combined into a single module embodied in hardware, software, firmware, and/or a combination thereof. For example, in some embodiments, one or more of the sets of circuitry, for example the AI and machine learning circuitry 310, may be combined with the processor 302, such that the processor 302 performs one or more of the operations described herein with respect to the AI and machine learning circuitry 310.

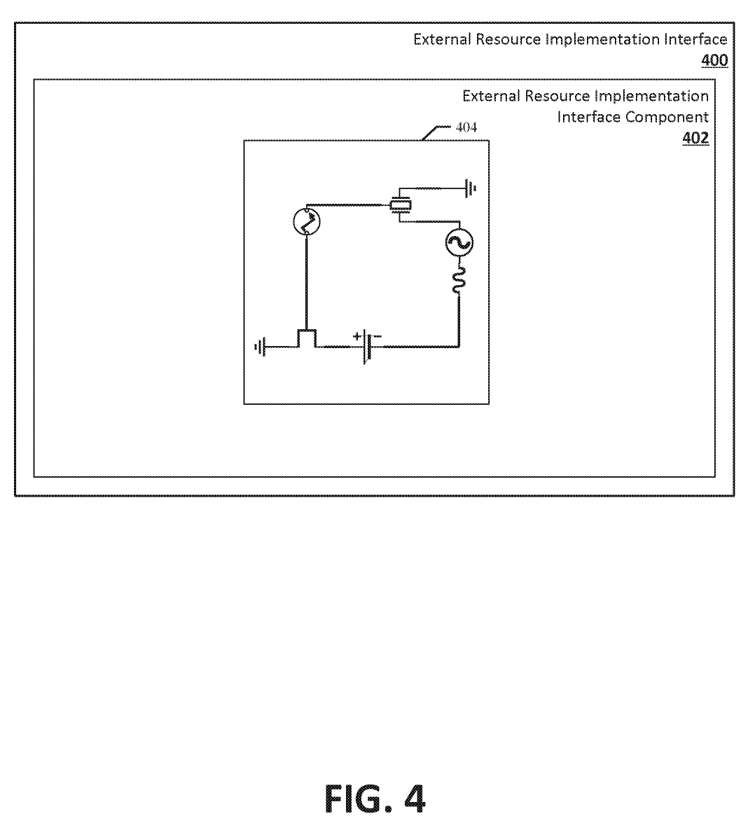

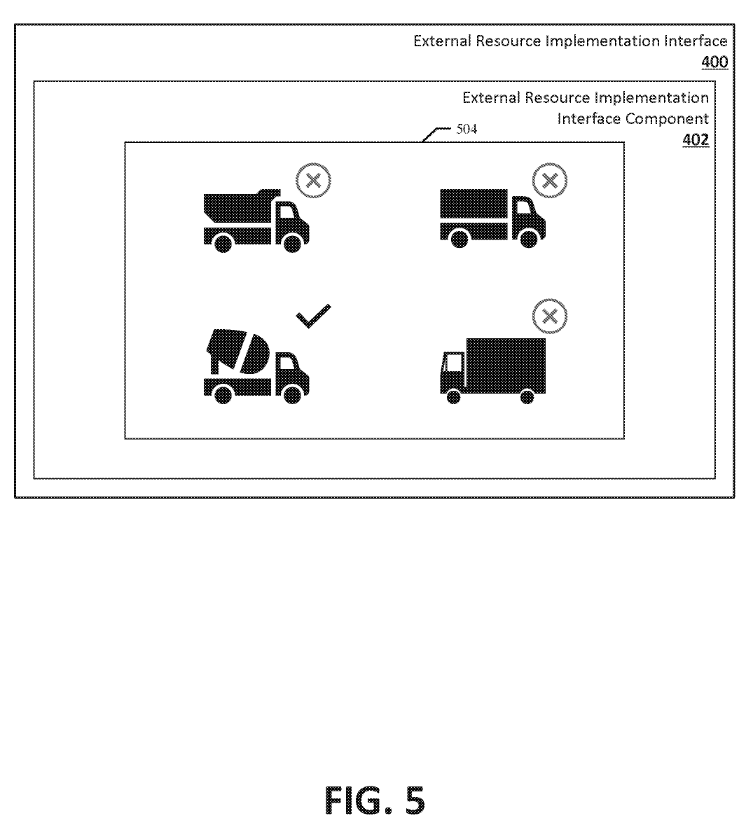

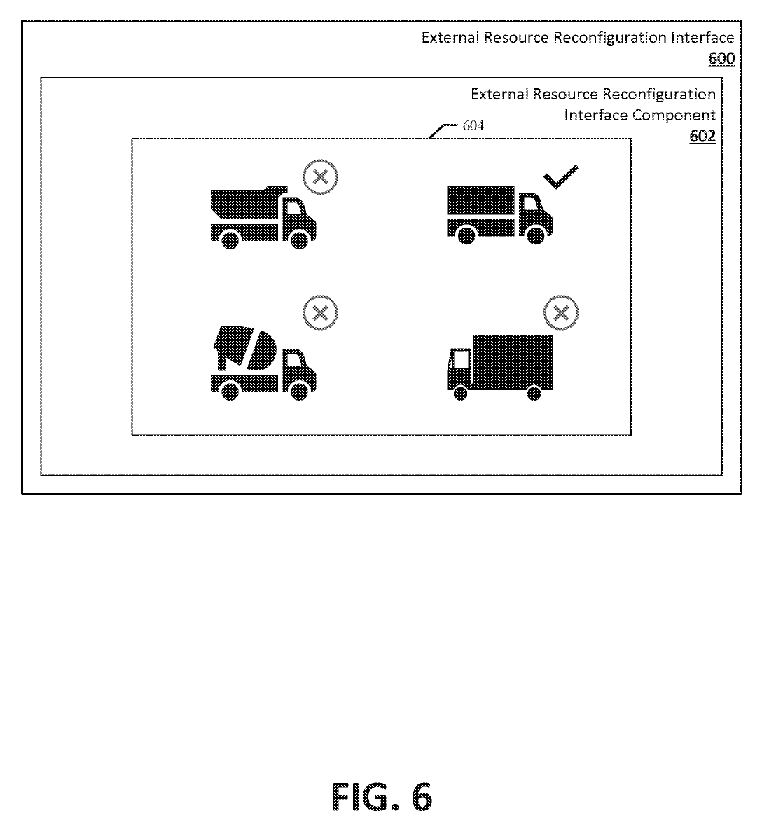

With reference to FIGS. 1-6, in some embodiments, a project may be a collection of components that may be implemented in a configured manner to accomplish one or more tasks. In this regard, for example, a project may be a collection of components that may be implemented in a configured manner in order to control the temperature of a building. For example, a project may be a collection of configured components that include temperature sensors, temperature control systems, circuits, and/or heating, ventilation, and air conditioning (HVAC) units that may be implemented in order to control the temperature of a building. In this regard, in some embodiments, a physical component may be any component configured to, in combination with other components, construct a configured component such as a temperature sensor, circuit, or HVAC unit.

In some embodiments, a project is associated with one or more requirement features. In some embodiments, a requirement feature comprises one or more items of data representative of a requirement, a criteria, and/or a constraint that must be satisfied in order to implement a project. For example, a requirement feature may be one or more items of data that are representative of a requirement, a criteria, and/or a constraint that must be satisfied in order to implement a project that includes controlling the temperature of a building. In this regard, for example, a requirement feature may be representative of a particular range in which the temperature of a building must be controlled to stay within (e.g., a requirement). As another example, a requirement feature may be representative of a physical layout of a building in which the temperature is to be controlled (e.g., a constraint). As another example, a requirement feature may be representative of an implementation time for a project (e.g., how long it may take to implement a project, when a project must be implemented, etc.). As another example, a requirement feature may be representative of a geographic location associated with a project (e.g., where a project should be implemented, a restriction on where resources for a project should be obtained from, etc.).

In some embodiments, a physical component object comprises one or more items of data representative of a physical component that may be implemented in a project. For example, a physical component object may be representative of a temperature sensor, a circuit, an HVAC unit or any discrete, individual component used to construct a temperature sensor, a circuit, or an HVAC unit. Said differently, for example, a physical component object may be representative of a physical component that may form a portion of a project.

In some embodiments, a project physical component record comprises one or more items of data representative of one or more physical components required to implement a project. In this regard, in some embodiments, a project physical component record comprises one or more physical component objects associated with one or more physical components to be used in a project.

In some embodiments, the cloud-based project operations device 140 is configured to access a first project physical component record. For example, the cloud-based project operations device 140 may be configured to access a first project physical component record at the project orchestration predictive computing entity 204 (e.g., the cloud-based project operations device 140 is configured to access a first project physical component record using the project orchestration predictive computing entity 204). In some embodiments, a first project physical component record comprises one or more physical component objects. In this regard, for example, a first project physical component record may comprise one or more physical component objects that each correspond to a first project.

In some embodiments, accessing a first project physical component record comprises the cloud-based project operations device 140 being configured to retrieve a first project physical component record. For example, the cloud-based project operations device 140 may be configured to retrieve a first project physical component record from the one or more databases 150 using the project orchestration predictive computing entity 204. As another example, cloud-based project operations device 140 may be configured to retrieve a first project physical component record from the internal databases 224 using the project orchestration predictive computing entity 204. In some embodiments, accessing a first project physical component record comprises the cloud-based project operations device 140 being configured to receive a first project physical component record. For example, the cloud-based project operations device 140 may be configured to receive a first project physical component record from the project foundation device 180. As another example, the cloud-based project operations device 140 may be configured to receive a first project physical component record from the external project application device 110. In some embodiments, prior to the cloud-based project operations device 140 accessing a first project physical component record at the project orchestration predictive computing entity 204, a first project physical component record may be processed by the project operations security layer 202 using one or more cybersecurity operations. In some embodiments, accessing a first project physical component record comprises the cloud-based project operations device 140 providing access to a first project physical component record to inventory predictive computing entity 206 via project orchestration predictive computing entity 204.

In some embodiments, the cloud-based project operations device 140 is configured to retrieve a set of candidate external resource objects from an external resource object database. For example, the cloud-based project operations device 140 may be configured to retrieve a set of candidate external resource objects from the external resource object database using the inventory predictive computing entity 206. As another example, cloud-based project operations device 140 may be configured to retrieve a set of candidate external resource objects from the external resource object database using the project orchestration predictive computing entity 204. In some embodiments, the one or more databases 150 comprises the external resource object database. In some embodiments, the internal database 224 comprises the external resource object database.

In some embodiments, a set of candidate external resource objects comprises one or more external resource objects. For example, a set of candidate external resource objects may comprise a first external resource object. In some embodiments, an external resource object comprises one or more items of data representative of an external resource entity that produces, manufactures, and/or provides access to a physical component associated with a physical component object (e.g., an external resource entity being a manufacturer of a physical component). In some embodiments, the cloud-based project operations device 140 is configured to retrieve a set of external resource objects based on the physical component object. In this regard, in some embodiments, a candidate external resource object comprises one or more items of data representative of an external resource entity that produces, manufactures, and/or provides access to a physical component associated with a physical component object that may be associated with a project physical component record accessed by the cloud-based project operations device 140.

In some embodiments, an external resource object is associated with an external resource feature. In this regard, in some embodiments, when the cloud-based project operations device 140 retrieves a set of candidate external resource objects, the cloud-based project operations device 140 may be configured to retrieve an external resource feature corresponding to each of a set of candidate external resource objects. In some embodiments, an external resource feature comprises one or more items of data representative and/or indicative of a capability, characteristic, and/or the like of an external resource object. In this regard, in some embodiments, an external resource feature comprises an external resource configuration feature. In some embodiments, an external resource configuration feature comprises one or more items of data representative and/or indicative of one or more physical components that an associated external resource object produces, manufactures, and/or provides access to. For example, an external resource configuration feature may indicate that an associated external resource object manufactures one or more temperature sensors.

Additionally, or alternatively, an external resource feature comprises an external resource generation feature. In some embodiments, an external resource generation feature comprises one or more items of data representative and/or indicative of one or more processes and/or systems used by an associated external resource object for producing, manufacturing, and/or providing access to one or more physical components. For example, an external resource generation feature may indicate that an associated external resource object manufactures one or more temperature sensors using a particular manufacturing process and/or a particular system (e.g., a 3D printer).

Additionally, or alternatively, an external resource feature comprises an external resource volume feature. In some embodiments, an external resource volume feature comprises one or more items of data representative and/or indicative of a number of physical components that an associated external resource object is able to produce, manufacture, and/or provide access to. For example, an external resource volume feature may indicate that an associated external resource object is able to produce fifty temperature sensors. Additionally, or alternatively, an external resource feature comprises an external resource temporal feature. In some embodiments, an external resource temporal feature comprises one or more items of data representative and/or indicative of an amount of time it many take for an associated external resource object to produce, manufacture, and/or provide access to a particular number of physical components. For example, an external resource temporal feature may indicate that an associated external resource object is able to provide access to fifty temperature sensors in one week.

Additionally, or alternatively, an external resource feature comprises an external resource geographic feature. In some embodiments, an external resource geographic feature comprises one or more items of data representative and/or indicative of a physical location of an associated external resource object. For example, an external resource geographic feature may indicate that an associated external resource object is physically located in a particular country. Additionally, or alternatively, an external resource feature comprises an external resource impact feature. In some embodiments, an external resource impact feature comprises one or more items of data representative and/or indicative of a prior performance of an associated external resource object when producing, manufacturing, and/or providing access to one or more physical components. Additionally, or alternatively, an external resource feature comprises an external resource operations feature. In some embodiments, an external resource operations feature comprises one or more items of data representative and/or indicative of one or more projects an external resource object is associated with. For example, an external resource operations feature may indicate that an external resource object is currently producing, manufacturing, and/or providing access to physical components for multiple different projects.

In some embodiments, the cloud-based project operations device 140 is configured to extract a first external resource object from a set of candidate external resource objects. In some embodiments, the cloud-based project operations device 140 is configured to extract the first external resource object from a set of candidate external resource objects using the inventory predictive computing entity 206. In some embodiments, the cloud-based project operations device 140 is configured to extract the first external resource object from a set of candidate external resource objects by applying the physical component object and/or the set of candidate external resource objects associated with the physical component object to an external resource prediction model.

In some embodiments, extracting the first external resource object from a set of candidate external resource objects comprises the cloud-based project operations device 140 being configured to generate an external resource prediction for the first external resource object. In some embodiments, the cloud-based project operations device 140 is configured to generate an external resource prediction for the first external resource object using the external resource prediction model. In some embodiments, the external resource prediction model is configured to generate an external resource prediction based on an external resource feature and/or a requirement feature associated with a particular project. In some embodiments, an external resource prediction comprises one or more items of data representative and/or indicative of a prediction of whether a first external resource entity (e.g., represented by the first external resource object) will be able to produce, manufacture, and/or provide access to a physical component in accordance with a requirement feature of a particular project based on an external resource feature associated with the first external resource object. In this regard, for example, an external resource prediction may be a prediction of whether the first external resource entity will be able to produce, manufacture, and/or provide access to a physical component in accordance with a requirement feature of a particular project based on whether the first external resource entity produces, manufacturers, and/or provides access to the physical component (e.g., an external resource configuration feature). As another example, an external resource prediction may be a prediction of whether the first external resource entity will be able to produce, manufacture, and/or provide access to a physical component in accordance with a requirement feature of a particular project based on whether the first external resource entity uses acceptable processes and/or systems for manufacturing the physical component (e.g., an external resource generation feature). As another example, an external resource prediction may be a prediction of whether the first external resource entity will be able to produce, manufacture, and/or provide access to a physical component in accordance with a requirement feature of a particular project based on whether the first external resource entity is able to manufacture an acceptable number of the physical component (e.g., an external resource volume feature).

As another example, an external resource prediction may be a prediction of whether the first external resource entity will be able to produce, manufacture, and/or provide access to a physical component in accordance with a requirement feature of a particular project based on whether the first external resource entity is able to produce the physical component within a particular timeline (e.g., an external resource temporal feature). As another example, an external resource prediction may be a prediction of whether the first external resource entity will be able to produce, manufacture, and/or provide access to a physical component in accordance with a requirement feature of a particular project based on whether the first external resource entity is located in an acceptable physical location for producing the physical component (e.g., an external resource geographic feature). As another example, an external resource prediction may be a prediction of whether the first external resource entity will be able to produce, manufacture, and/or provide access to a physical component in accordance with a requirement feature of a particular project based on whether a prior performance (e.g., cost, etc.) of the first external resource entity indicates that the first external resource entity will be able to produce the physical component (e.g., an external resource impact feature). In some embodiments, if the external resource prediction indicates that the first external resource entity will be able to produce, manufacture, and/or provide access to a physical component in accordance with a requirement feature of a particular project based on an external resource feature associated with the first external resource object, the cloud-based project operations device 140 is configured to extract the first external resource object from the set of candidate external resource objects.

In some embodiments, extracting the first external resource object from a set of candidate external resource objects comprises the cloud-based project operations device 140 being configured to generate a project entity prediction. In some embodiments, the cloud-based project operations device 140 is configured to generate a project entity prediction for the first external resource object using the external resource prediction model. In some embodiments, the external resource prediction model is configured to generate a project entity prediction based on a secondary physical component record and/or an external resource feature. In some embodiments, a project entity prediction comprises one or more items of data representative and/or indicative of a prediction of whether the first external resource entity will be able to produce, manufacture, and/or provide access to a physical component in accordance with a requirement feature of a particular project based on a secondary project component record and/or an external resource feature. In some embodiments, the secondary project component record may be a project component record that is associated with a different project than the first project component record. In some embodiments, both the first project component record and the second project component record may be associated with the cloud-based project operations device 140.

In some embodiments, a project entity prediction comprises one or more items of data representative and/or indicative of a prediction of whether the first external resource entity will be able to produce, manufacture, and/or provide access to a physical component in accordance with a requirement feature of a particular project based on whether the secondary project component record indicates that another project may impact the first external resource entity’s ability to produce, manufacture, and/or provide access to the physical component in accordance with the requirement feature. Said differently, for example, a project entity prediction may be a prediction of whether a second project associated with the secondary physical component record may impact the first external resource entity’s ability to produce, manufacture, and/or provide access to a physical component in accordance with a requirement feature of a first project associated with the first project physical component record. For example, if the first project and the second project both require 50 temperature sensors and the first external resource entity is only able to provide 50 temperature sensors (e.g., based on an external resource feature associated with the first external resource object), a project entity prediction may indicate that second project associated with the secondary physical component record may impact the first external resource entity’s ability to produce, manufacture, and/or provide access to the 50 temperature sensors for the first project. As another example, if the first project and the second project both require 25 temperature sensors and the first external resource entity is able to provide 50 temperature sensors (e.g., based on an external resource feature associated with the first external resource object), a project entity prediction may indicate that second project associated with the secondary physical component record does not impact the first external resource entity’s ability to produce, manufacture, and/or provide access to the 25 temperature sensors for the first project. In some embodiments, if the project entity prediction indicates that the secondary physical component record (e.g., the second project) will not impact the first external resource entity’s ability to produce, manufacture, and/or provide access to a physical component in accordance with a requirement feature of a first project associated with the first project physical component record, the cloud-based project operations device 140 is configured to extract the first external resource object from the set of candidate external resource objects.

In some embodiments, the cloud-based project operations device 140 is configured to perform one or more external resource implementation actions. For example, the cloud-based project operations device 140 is configured to perform one or more external resource implementation actions using the project orchestration predictive computing entity 204. In some embodiments, the cloud-based project operations device 140 is configured to perform one or more external resource implementation actions based on the first external resource object. In some embodiments, the cloud-based project operations device 140 is configured to perform one or more external resource implementation actions based on the external resource prediction. In some embodiments, the cloud-based project operations device 140 is configured to perform one or more external resource implementation actions based on the project entity prediction. In this regard, for example, the cloud-based project operations device 140 may be configured to perform one or more external resource implementation actions in order to execute, implement, and/or the like a plan, design, and/or process for implementing a project using a first external resource object.

In some embodiments, performing one or more external resource implementation actions comprises the cloud-based project operations device 140 being configured to generate an external resource implementation interface component 402. In some embodiments, the external resource implementation interface component 402 is configured to display a physical component object representation 404 that is representative of one or more physical component objects. For example, the physical component object representation 404 may be a representation of a physical component object for use by a plan for implementing a first project corresponding to a first project physical component record. In some embodiments, the external resource implementation interface component 402 is configured to display an external resource prediction representation 504 that is representative of an external resource prediction. For example, the external resource prediction representation 504 may be a representation of a first external resource object associated with a first external resource entity predicted to have a capability to provide access to a physical component associated with a physical component object identified by the first project physical component record above a threshold value.

In some embodiments, performing one or more external resource implementation actions comprises the cloud-based project operations device 140 being configured to cause an external resource implementation interface component 402 to be rendered to external resource implementation interface 400. In some embodiments, the external resource implementation interface 400 may be provided on a display associated with the cloud-based project operations device 140 and/or a display associated with the project foundation device 180.

In some embodiments, performing one or more external resource implementation actions comprises the cloud-based project operations device 140 being configured to execute one or more external resource implementation computing scripts. In this regard, in some embodiments, the one or more external resource implementation computing scripts comprise executable code configured to cause execution of at least a portion of a plan, design, and/or process for implementing a first project. In some embodiments, execution of one or more external resource implementation computing scripts comprises executing code that causes procurement of physical components and/or resources associated with a first project physical component record. In some embodiments, execution of one or more external resource implementation computing scripts comprises executing code that causes procurement of physical components and/or resources associated with a first project physical component record from a first external resource entity associated with a first external resource object. In some embodiments, execution of one or more external resource implementation computing scripts comprises executing code that causes actuation of a device that manufactures a physical component associated with a first project physical component record (e.g., to turn on, create the physical component, and/or to shut down). In some embodiments, execution of one or more external resource implementation computing scripts comprises executing code that causes a determination that an external resource prediction satisfies a threshold. In some embodiments, execution of one or more external resource implementation computing scripts comprises executing code that causes a determination that an external resource prediction does not satisfy a threshold. In some embodiments, execution of one or more external resource implementation computing scripts comprises executing code that causes a determination that a project entity prediction satisfies a threshold. In some embodiments, execution of one or more external resource implementation computing scripts comprises executing code that causes a determination that a project entity prediction does not satisfy a threshold.

In some embodiments, the cloud-based project operations device 140 is configured to identify an external resource impact event associated with a first external resource object. In some embodiments, the cloud-based project operations device 140 is configured to identify an external resource impact event associated with an external resource entity associated with an external resource object. In some embodiments, the one or more external resource implementation actions may be performed prior to identifying the external resource impact event. In some embodiments, an external resource impact event is any occurrence that causes a change to the capability of a first external resource entity to provide access to a physical component associated with a physical component object identified by the first project physical component record. In this regard, in some embodiments, a external resource impact event may comprise a change to a physical component object, an external resource feature, and/or the first project physical component record. In some embodiments, identifying an external resource impact event comprises the cloud-based project operations device 140 being configured to receive the external resource impact event from external project application device 110. In some embodiments, identifying an external resource impact event comprises the cloud-based project operations device 140 being configured to receive the external resource impact event from project foundation device 180.

In some embodiments, identifying an external resource impact event comprises execution, by the cloud-based project operations device 140, of one or more external resource impact event computing scripts. In some embodiments, the cloud-based project operations device 140 is configured to execute the one or more external resource impact event computing scripts using the inventory predictive computing entity 206. In some embodiments, execution of one or more external resource impact event computing scripts comprises executing code that causes a web scraper to extract an external resource impact event indicator from an external event source (e.g., an Internet source). In some embodiments, execution of one or more external resource impact event computing scripts comprises executing code that causes a web crawler to extract an external resource impact event indicator from an external event source. In some embodiments, execution of one or more external resource impact event computing scripts comprises executing code that causes monitoring of networked data packets to extract an external resource impact event indicator.

In some embodiments, the cloud-based project operations device 140 is configured to extract an additional external resource object from a set of candidate external resource objects. In some embodiments, the cloud-based project operations device 140 is configured to extract the additional external resource object from a set of candidate external resource objects using the inventory predictive computing entity 206. In some embodiments, the cloud-based project operations device 140 is configured to extract the additional external resource object from a set of candidate external resource objects by applying the physical component object, the external resource impact event, and/or the set of candidate external resource objects associated with the physical component object to an external resource prediction model. For example, the cloud-based project operations device 140 may be configured to extract the additional external resource object in response to identifying an external resource event.

In some embodiments, extracting the additional external resource object from a set of candidate external resource objects comprises the cloud-based project operations device 140 being configured to generate an additional external resource prediction for the additional external resource object. In some embodiments, the cloud-based project operations device 140 is configured to generate an additional external resource prediction for the additional external resource object using the external resource prediction model. In this regard, in some embodiments, the external resource prediction model may be configured to generate an additional external resource prediction for the additional external resource object using a similar process as described above with respect to generating the external resource prediction for the first external resource object. For example, an additional external resource prediction for the additional external resource object may be generated by the external resource prediction model based on an additional external resource feature associated with the additional external resource object.

In some embodiments, extracting the additional external resource object from a set of candidate external resource objects comprises the cloud-based project operations device 140 being configured to generate an additional project entity prediction. In some embodiments, the cloud-based project operations device 140 is configured to generate an additional project entity prediction for the additional external resource object using the external resource prediction model. In this regard, in some embodiments, the external resource prediction model may be configured to generate an additional project entity prediction for the additional external resource object using a similar process as described above with respect to generating the project entity prediction for the first external resource object. For example, an additional project entity prediction for the additional external resource object may be generated by the external resource prediction model based on at least one of an additional external resource feature or an additional physical component record.

In some embodiments, the cloud-based project operations device 140 is configured to perform one or more external resource reconfiguration actions. For example, the cloud-based project operations device 140 is configured to perform one or more external resource reconfiguration actions using the project orchestration predictive computing entity 204. In some embodiments, the cloud-based project operations device 140 is configured to perform one or more external resource reconfiguration actions based on the additional external resource object. In some embodiments, the cloud-based project operations device 140 is configured to perform one or more external resource reconfiguration actions based on the additional external resource prediction. In some embodiments, the cloud-based project operations device 140 is configured to perform one or more external resource reconfiguration actions based on the additional project entity prediction. In this regard, for example, the cloud-based project operations device 140 may be configured to perform one or more external resource reconfiguration actions in order to execute, implement, and/or the like a plan, design, and/or process for implementing a project using an additional external resource object.

In some embodiments, performing one or more external resource reconfiguration actions comprises the cloud-based project operations device 140 being configured to generate an external resource reconfiguration interface component 602. In some embodiments, the external resource reconfiguration interface component 602 is configured to display a physical component object representation 404 that is representative of one or more physical component objects. For example, the physical component object representation 404 may be a representation of a physical component object for use by a plan for implementing the proposed project corresponding to a project physical component record. In some embodiments, the external resource reconfiguration interface component 602 is configured to display an additional external resource prediction representation 604 that is representative of an additional external resource prediction. For example, the additional external resource prediction representation 604 may be a representation of an additional external resource object associated with an additional external resource entity predicted to have a capability to provide access to a physical component associated with a physical component object identified by the project physical component record that further satisfies a threshold than the external resource entity due to the external resource impact event.

In some embodiments, performing one or more external resource reconfiguration actions comprises the cloud-based project operations device 140 being configured to cause an external resource reconfiguration interface component 602 to be rendered to external resource reconfiguration interface 600. In some embodiments, the external resource reconfiguration interface 600 may be provided on a display associated with the cloud-based project operations device 140 and/or a display associated with the project foundation device 180.

In some embodiments, performing one or more external resource reconfiguration actions comprises the cloud-based project operations device 140 being configured to execute one or more external resource reconfiguration computing scripts. In this regard, in some embodiments, the one or more external resource reconfiguration computing scripts comprise executable code configured to cause execution of at least a portion of a plan, design, and/or process for implementing a project. In some embodiments, execution of one or more external resource reconfiguration computing scripts comprises executing code that causes procurement of physical components and/or resources associated with a project physical component record. In some embodiments, execution of one or more external resource reconfiguration computing scripts comprises executing code that causes procurement of physical components and/or resources associated with a project physical component record from an additional external resource entity associated with an additional external resource object. In some embodiments, execution of one or more external resource reconfiguration computing scripts comprises executing code that causes actuation of a device that manufactures a physical component associated with a project physical component record (e.g., to turn on, create the physical component, and/or to shut down). In some embodiments, execution of one or more external resource reconfiguration computing scripts comprises executing code that causes a determination that an additional external resource prediction satisfies a threshold. In some embodiments, execution of one or more external resource reconfiguration computing scripts comprises executing code that causes a determination that an additional external resource prediction does not satisfy a threshold. In some embodiments, execution of one or more external resource reconfiguration computing scripts comprises executing code that causes a determination that an additional project entity prediction satisfies a threshold. In some embodiments, execution of one or more external resource reconfiguration computing scripts comprises executing code that causes a determination that an additional project entity prediction does not satisfy a threshold.

In some embodiments, the cloud-based project operations device 140 is configured to identify a project execution indication corresponding to the first project physical component record. In this regard, in some embodiments, the project execution indication comprises one or more items of data representative of the execution of a first project associated with the first project physical component record (e.g., an indication that the project has concluded).

In some embodiments, the external resource prediction model comprises hardware and/or software that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate a first external resource prediction, a project entity prediction, an additional external resource prediction, and an additional project entity prediction. In this regard, in some embodiments, the external resource prediction model may be configured to utilize one or more of any type of machine learning, rules-based, and/or artificial intelligence techniques including one or more of clustering techniques (e.g., k-means techniques, expectation maximization techniques, centroid neural network techniques), computer vision techniques, supervised learning (e.g., using user feedback), unsupervised learning, semi-supervised learning, reinforcement learning, sequence modeling techniques, language processing techniques, neural network techniques, and/or generative artificial intelligence techniques. In some embodiments, the external resource prediction model comprises one or more layers. For example, the external resource prediction model may comprise a first layer configured to generate a first external resource prediction. As another example, the external resource prediction model may comprise a second layer configured to generate a project entity prediction.

In some embodiments, the cloud-based project operations device 140 is configured to, upon identification of the project execution indication, store one or more of the first project physical component record, the set of candidate external resource objects, the first external resource object, the external resource prediction, the external resource feature, the project entity prediction, the secondary physical component record, the external resource impact event, the additional external resource object, the additional external resource prediction, the additional external resource feature, the additional project entity prediction, and/or the additional physical component record in the one or more databases 150.

In some embodiments, the cloud-based project operations device 140 is configured to train the external resource prediction model. In some embodiments, the cloud-based project operations device 140 is configured to train the external resource prediction model based on the first external resource object. Additionally, or alternatively, the cloud-based project operations device 140 is configured to train the external resource prediction model based one or more of the first external resource object, the external resource prediction, the external resource feature, the project entity prediction, the secondary physical component record, the external resource impact event, the additional external resource object, the additional external resource prediction, the additional external resource feature, the additional project entity prediction, and/or the additional physical component record. In this regard, in some embodiments, the external resource object, the external resource prediction, the external resource feature, the project entity prediction, the secondary physical component record, the external resource impact event, the additional external resource object, the additional external resource prediction, the additional external resource feature, the additional project entity prediction, and/or the additional physical component record previously accessed and/or generated by the cloud-based project operations device 140 may be able to be used by the cloud-based project operations device 140 to continually improve the external resource prediction model.

### Example Methods

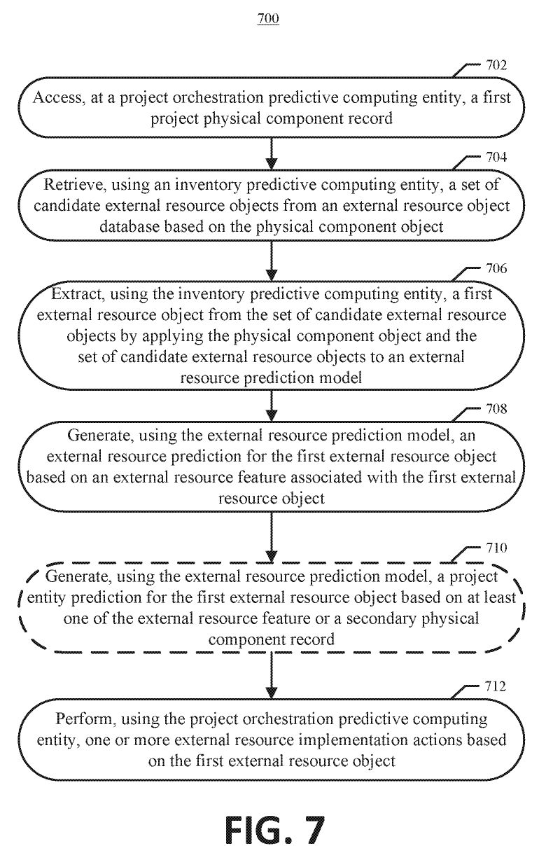

Referring now to FIG. 7, a flowchart providing an example method 700 is illustrated. In this regard, FIG. 7 illustrates operations that may be performed by the project foundation device 180, the external project implementation device 120, the external project application device 110, the cloud-based project operations device 140, the one or more databases 150, and/or the user device 170. In some embodiments, the method 700 comprises operations for extracting an external resource object from a set of candidate external resource objects. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method 700 may comprise accessing, at a project orchestration predictive computing entity, a first project physical component record. In some embodiments, the first project physical component record comprises a physical component object. As described above, in some embodiments, the cloud-based project operations device 140 is configured to access a first project physical component record. For example, the cloud-based project operations device 140 may be configured to access a first project physical component record at the project orchestration predictive computing entity 204 (e.g., the cloud-based project operations device 140 is configured to access a first project physical component record using the project orchestration predictive computing entity 204). In some embodiments, a first project physical component record comprises one or more physical component objects. In this regard, for example, a first project physical component record may comprise one or more physical component objects that each correspond to a first project.

In some embodiments, accessing a first project physical component record comprises the cloud-based project operations device 140 being configured to retrieve a first project physical component record. For example, the cloud-based project operations device 140 may be configured to retrieve a first project physical component record from the one or more databases 150 using the project orchestration predictive computing entity 204. As another example, cloud-based project operations device 140 may be configured to retrieve a first project physical component record from the internal databases 224 using the project orchestration predictive computing entity 204. In some embodiments, accessing a first project physical component record comprises the cloud-based project operations device 140 being configured to receive a first project physical component record. For example, the cloud-based project operations device 140 may be configured to receive a first project physical component record from the project foundation device 180. As another example, the cloud-based project operations device 140 may be configured to receive a first project physical component record from the external project application device 110. In some embodiments, prior to the cloud-based project operations device 140 accessing a first project physical component record at the project orchestration predictive computing entity 204, a first project physical component record may be processed by the project operations security layer 202 using one or more cybersecurity operations. In some embodiments, accessing a first project physical component record comprises the cloud-based project operations device 140 providing access to a first project physical component record to inventory predictive computing entity 206 via project orchestration predictive computing entity 204.

As shown in block 704, the method 700 may comprise retrieving, using an inventory predictive computing entity, a set of candidate external resource objects from an external resource object database based on the physical component object. As described above, in some embodiments, the cloud-based project operations device 140 is configured to retrieve a set of candidate external resource objects from an external resource object database. For example, the cloud-based project operations device 140 may be configured to retrieve a set of candidate external resource objects from the external resource object database using the inventory predictive computing entity 206. As another example, cloud-based project operations device 140 may be configured to retrieve a set of candidate external resource objects from the external resource object database using the project orchestration predictive computing entity 204. In some embodiments, the one or more databases 150 comprises the external resource object database. In some embodiments, the internal database 224 comprises the external resource object database.

As shown in block 706, the method 700 may comprise extracting, using the inventory predictive computing entity, a first external resource object from the set of candidate external resource objects by applying the physical component object and the set of candidate external resource objects to an external resource prediction model. As described above, in some embodiments, the cloud-based project operations device 140 is configured to extract a first external resource object from a set of candidate external resource objects. In some embodiments, the cloud-based project operations device 140 is configured to extract the first external resource object from a set of candidate external resource objects using the inventory predictive computing entity 206. In some embodiments, the cloud-based project operations device 140 is configured to extract the first external resource object from a set of candidate external resource objects by applying the physical component object and/or the set of candidate external resource objects associated with the physical component object to an external resource prediction model.

As shown in block 708, the method 700 may comprise generating, using the external resource prediction model, an external resource prediction for the first external resource object based on an external resource feature associated with the first external resource object. As described above, in some embodiments, extracting the first external resource object from a set of candidate external resource objects comprises the cloud-based project operations device 140 being configured to generate an external resource prediction for the first external resource object. In some embodiments, the cloud-based project operations device 140 is configured to generate an external resource prediction for the first external resource object using the external resource prediction model. In some embodiments, the external resource prediction model is configured to generate an external resource prediction based on an external resource feature and/or a requirement feature associated with a particular project. In some embodiments, an external resource prediction comprises one or more items of data representative and/or indicative of a prediction of whether a first external resource entity (e.g., represented by the first external resource object) will be able to produce, manufacture, and/or provide access to a physical component in accordance with a requirement feature of a particular project based on an external resource feature associated with the first external resource object. In this regard, for example, an external resource prediction may be a prediction of whether the first external resource entity will be able to produce, manufacture, and/or provide access to a physical component in accordance with a requirement feature of a particular project based on whether the first external resource entity produces, manufacturers, and/or provides access to the physical component (e.g., an external resource configuration feature). As another example, an external resource prediction may be a prediction of whether the first external resource entity will be able to produce, manufacture, and/or provide access to a physical component in accordance with a requirement feature of a particular project based on whether the first external resource entity uses acceptable processes and/or systems for manufacturing the physical component (e.g., an external resource generation feature). As another example, an external resource prediction may be a prediction of whether the first external resource entity will be able to produce, manufacture, and/or provide access to a physical component in accordance with a requirement feature of a particular project based on whether the first external resource entity is able to manufacture an acceptable number of the physical component (e.g., an external resource volume feature).

As another example, an external resource prediction may be a prediction of whether the first external resource entity will be able to produce, manufacture, and/or provide access to a physical component in accordance with a requirement feature of a particular project based on whether the first external resource entity is able to produce the physical component within a particular timeline (e.g., an external resource temporal feature). As another example, an external resource prediction may be a prediction of whether the first external resource entity will be able to produce, manufacture, and/or provide access to a physical component in accordance with a requirement feature of a particular project based on whether the first external resource entity is located in an acceptable physical location for producing the physical component (e.g., an external resource geographic feature). As another example, an external resource prediction may be a prediction of whether the first external resource entity will be able to produce, manufacture, and/or provide access to a physical component in accordance with a requirement feature of a particular project based on whether a prior performance (e.g., cost, etc.) of the first external resource entity indicates that the first external resource entity will be able to produce the physical component (e.g., an external resource impact feature). In some embodiments, if the external resource prediction indicates that the first external resource entity will be able to produce, manufacture, and/or provide access to a physical component in accordance with a requirement feature of a particular project based on an external resource feature associated with the first external resource object, the cloud-based project operations device 140 is configured to extract the first external resource object from the set of candidate external resource objects.

As shown in block 710, the method 700 may comprise generating, using the external resource prediction model, a project entity prediction for the first external resource object based on at least one of the external resource feature or a secondary physical component record. As described above, in some embodiments, extracting the first external resource object from a set of candidate external resource objects comprises the cloud-based project operations device 140 being configured to generate a project entity prediction. In some embodiments, the cloud-based project operations device 140 is configured to generate a project entity prediction for the first external resource object using the external resource prediction model. In some embodiments, the external resource prediction model is configured to generate a project entity prediction based on a secondary physical component record and/or an external resource feature. In some embodiments, a project entity prediction comprises one or more items of data representative and/or indicative of a prediction of whether the first external resource entity will be able to produce, manufacture, and/or provide access to a physical component in accordance with a requirement feature of a particular project based on a secondary project component record and/or an external resource feature. In some embodiments, the secondary project component record may be a project component record that is associated with a different project than the first project component record. In some embodiments, both the first project component record and the second project component record may be associated with the cloud-based project operations device 140.

In some embodiments, a project entity prediction comprises one or more items of data representative and/or indicative of a prediction of whether the first external resource entity will be able to produce, manufacture, and/or provide access to a physical component in accordance with a requirement feature of a particular project based on whether the secondary project component record indicates that another project may impact the first external resource entity’s ability to produce, manufacture, and/or provide access to the physical component in accordance with the requirement feature. Said differently, for example, a project entity prediction may be a prediction of whether a second project associated with the secondary physical component record may impact the first external resource entity’s ability to produce, manufacture, and/or provide access to a physical component in accordance with a requirement feature of a first project associated with the first project physical component record. For example, if the first project and the second project both require 50 temperature sensors and the first external resource entity is only able to provide 50 temperature sensors (e.g., based on an external resource feature associated with the first external resource object), a project entity prediction may indicate that second project associated with the secondary physical component record may impact the first external resource entity’s ability to produce, manufacture, and/or provide access to the 50 temperature sensors for the first project. As another example, if the first project and the second project both require 25 temperature sensors and the first external resource entity is able to provide 50 temperature sensors (e.g., based on an external resource feature associated with the first external resource object), a project entity prediction may indicate that second project associated with the secondary physical component record does not impact the first external resource entity’s ability to produce, manufacture, and/or provide access to the 25 temperature sensors for the first project. In some embodiments, if the project entity prediction indicates that the secondary physical component record (e.g., the second project) will not impact the first external resource entity’s ability to produce, manufacture, and/or provide access to a physical component in accordance with a requirement feature of a first project associated with the first project physical component record, the cloud-based project operations device 140 is configured to extract the first external resource object from the set of candidate external resource objects.

As shown in block 712, the method 700 may comprise performing, using the project orchestration predictive computing entity, one or more external resource implementation actions based on the first external resource object. As described above, in some embodiments, the cloud-based project operations device 140 is configured to perform one or more external resource implementation actions. For example, the cloud-based project operations device 140 is configured to perform one or more external resource implementation actions using the project orchestration predictive computing entity 204. In some embodiments, the cloud-based project operations device 140 is configured to perform one or more external resource implementation actions based on the first external resource object. In some embodiments, the cloud-based project operations device 140 is configured to perform one or more external resource implementation actions based on the external resource prediction. In some embodiments, the cloud-based project operations device 140 is configured to perform one or more external resource implementation actions based on the project entity prediction. In this regard, for example, the cloud-based project operations device 140 may be configured to perform one or more external resource implementation actions in order to execute, implement, and/or the like a plan, design, and/or process for implementing a project using a first external resource object.

In some embodiments, performing one or more external resource implementation actions comprises the cloud-based project operations device 140 being configured to generate an external resource implementation interface component 402. In some embodiments, the external resource implementation interface component 402 is configured to display a physical component object representation 404 that is representative of one or more physical component objects. For example, the physical component object representation 404 may be a representation of a physical component object for use by a plan for implementing a first project corresponding to a first project physical component record. In some embodiments, the external resource implementation interface component 402 is configured to display an external resource prediction representation 504 that is representative of an external resource prediction. For example, the external resource prediction representation 504 may be a representation of a first external resource object associated with a first external resource entity predicted to have a capability to provide access to a physical component associated with a physical component object identified by the first project physical component record above a threshold value.

In some embodiments, performing one or more external resource implementation actions comprises the cloud-based project operations device 140 being configured to cause an external resource implementation interface component 402 to be rendered to external resource implementation interface 400. In some embodiments, the external resource implementation interface 400 may be provided on a display associated with the cloud-based project operations device 140 and/or a display associated with the project foundation device 180.

In some embodiments, performing one or more external resource implementation actions comprises the cloud-based project operations device 140 being configured to execute one or more external resource implementation computing scripts. In this regard, in some embodiments, the one or more external resource implementation computing scripts comprise executable code configured to cause execution of at least a portion of a plan, design, and/or process for implementing a first project. In some embodiments, execution of one or more external resource implementation computing scripts comprises executing code that causes procurement of physical components and/or resources associated with a first project physical component record. In some embodiments, execution of one or more external resource implementation computing scripts comprises executing code that causes procurement of physical components and/or resources associated with a first project physical component record from a first external resource entity associated with a first external resource object. In some embodiments, execution of one or more external resource implementation computing scripts comprises executing code that causes actuation of a device that manufactures a physical component associated with a first project physical component record (e.g., to turn on, create the physical component, and/or to shut down). In some embodiments, execution of one or more external resource implementation computing scripts comprises executing code that causes a determination that an external resource prediction satisfies a threshold. In some embodiments, execution of one or more external resource implementation computing scripts comprises executing code that causes a determination that an external resource prediction does not satisfy a threshold. In some embodiments, execution of one or more external resource implementation computing scripts comprises executing code that causes a determination that a project entity prediction satisfies a threshold. In some embodiments, execution of one or more external resource implementation computing scripts comprises executing code that causes a determination that a project entity prediction does not satisfy a threshold.

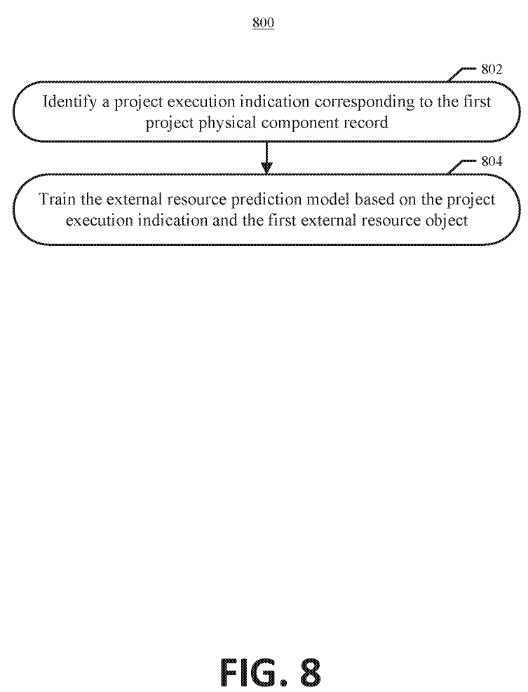

Referring now to FIG. 8, a flowchart providing an example method 800 is illustrated. In this regard, FIG. 8 illustrates operations that may be performed by the project foundation device 180, the external project implementation device 120, the external project application device 110, the cloud-based project operations device 140, the one or more databases 150, and/or the user device 170. In some embodiments, the method 800 comprises operations for training the external resource prediction model. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800.

As shown in block 802, the method 800 may comprise identifying a project execution indication corresponding to the first project physical component record. As described above, in some embodiments, the cloud-based project operations device 140 is configured to identify a project execution indication corresponding to the first project physical component record. In this regard, in some embodiments, the project execution indication comprises one or more items of data representative of the execution of a first project associated with the first project physical component record (e.g., an indication that the project has concluded).

As shown in block 804, the method 800 may comprise training the external resource prediction model based on the project execution indication and the first external resource object. As described above, in some embodiments, the cloud-based project operations device 140 is configured to, upon identification of the project execution indication, store one or more of the first project physical component record, the set of candidate external resource objects, the first external resource object, the external resource prediction, the external resource feature, the project entity prediction, the secondary physical component record, the external resource impact event, the additional external resource object, the additional external resource prediction, the additional external resource feature, the additional project entity prediction, and/or the additional physical component record in the one or more databases 150.

In some embodiments, the cloud-based project operations device 140 is configured to train the external resource prediction model. In some embodiments, the cloud-based project operations device 140 is configured to train the external resource prediction model based on the first external resource object. Additionally, or alternatively, the cloud-based project operations device 140 is configured to train the external resource prediction model based one or more of the first external resource object, the external resource prediction, the external resource feature, the project entity prediction, the secondary physical component record, the external resource impact event, the additional external resource object, the additional external resource prediction, the additional external resource feature, the additional project entity prediction, and/or the additional physical component record. In this regard, in some embodiments, the external resource object, the external resource prediction, the external resource feature, the project entity prediction, the secondary physical component record, the external resource impact event, the additional external resource object, the additional external resource prediction, the additional external resource feature, the additional project entity prediction, and/or the additional physical component record previously accessed and/or generated by the cloud-based project operations device 140 may be able to be used by the cloud-based project operations device 140 to continually improve the external resource prediction model.

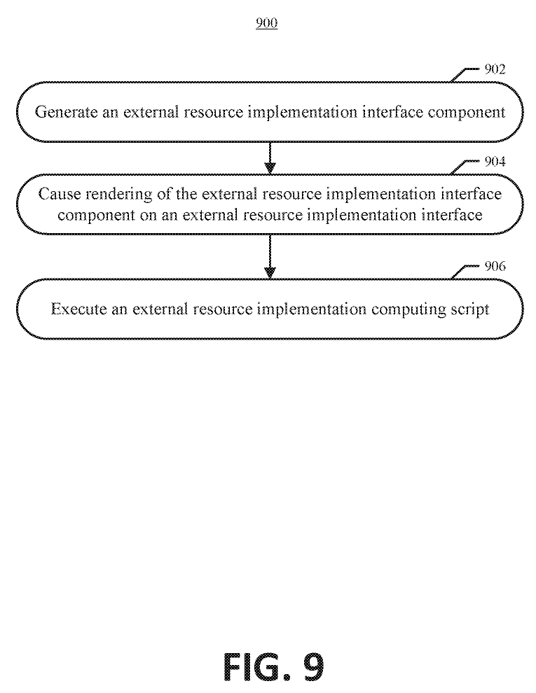

Referring now to FIG. 9, a flowchart providing an example method 900 is illustrated. In this regard, FIG. 9 illustrates operations that may be performed by the project foundation device 180, the external project implementation device 120, the external project application device 110, the cloud-based project operations device 140, the one or more databases 150, and/or the user device 170. In some embodiments, the method 900 comprises operations for performing the one or more external resource implementation actions. In some embodiments, the example method 900 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 900.

As shown in block 902, the method 900 may comprise generating an external resource implementation interface component. In some embodiments, the external resource implementation interface component comprises at least one of an external resource prediction representation or a physical component object representation. As described above, in some embodiments, performing one or more external resource implementation actions comprises the cloud-based project operations device 140 being configured to generate an external resource implementation interface component 402. In some embodiments, the external resource implementation interface component 402 is configured to display a physical component object representation 404 that is representative of one or more physical component objects. For example, the physical component object representation 404 may be a representation of a physical component object for use by a plan for implementing a first project corresponding to a first project physical component record. In some embodiments, the external resource implementation interface component 402 is configured to display an external resource prediction representation 504 that is representative of an external resource prediction. For example, the external resource prediction representation 504 may be a representation of a first external resource object associated with a first external resource entity predicted to have a capability to provide access to a physical component associated with a physical component object identified by the first project physical component record above a threshold value.

As shown in block 904, the method 900 may comprise causing rendering of the external resource implementation interface component on an external resource implementation interface. As described above, in some embodiments, performing one or more external resource implementation actions comprises the cloud-based project operations device 140 being configured to cause an external resource implementation interface component 402 to be rendered to external resource implementation interface 400. In some embodiments, the external resource implementation interface 400 may be provided on a display associated with the cloud-based project operations device 140 and/or a display associated with the project foundation device 180.

As shown in block 906, the method 900 may comprise executing an external resource implementation computing script. As described above, in some embodiments, performing one or more external resource implementation actions comprises the cloud-based project operations device 140 being configured to execute one or more external resource implementation computing scripts. In this regard, in some embodiments, the one or more external resource implementation computing scripts comprise executable code configured to cause execution of at least a portion of a plan, design, and/or process for implementing a first project. In some embodiments, execution of one or more external resource implementation computing scripts comprises executing code that causes procurement of physical components and/or resources associated with a first project physical component record. In some embodiments, execution of one or more external resource implementation computing scripts comprises executing code that causes procurement of physical components and/or resources associated with a first project physical component record from a first external resource entity associated with a first external resource object. In some embodiments, execution of one or more external resource implementation computing scripts comprises executing code that causes actuation of a device that manufactures a physical component associated with a first project physical component record (e.g., to turn on, create the physical component, and/or to shut down). In some embodiments, execution of one or more external resource implementation computing scripts comprises executing code that causes a determination that an external resource prediction satisfies a threshold. In some embodiments, execution of one or more external resource implementation computing scripts comprises executing code that causes a determination that an external resource prediction does not satisfy a threshold. In some embodiments, execution of one or more external resource implementation computing scripts comprises executing code that causes a determination that a project entity prediction satisfies a threshold. In some embodiments, execution of one or more external resource implementation computing scripts comprises executing code that causes a determination that a project entity prediction does not satisfy a threshold.

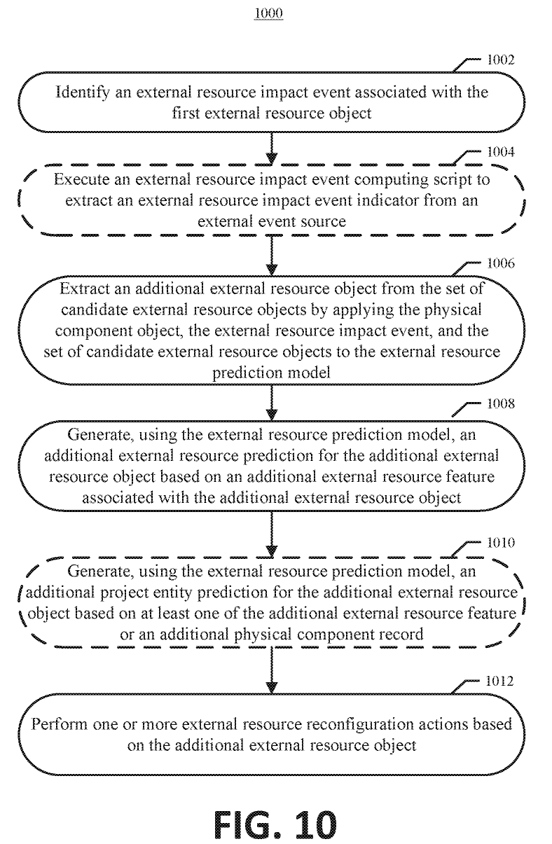

Referring now to FIG. 10, a flowchart providing an example method 1000 is illustrated. In this regard, FIG. 10 illustrates operations that may be performed by the project foundation device 180, the external project implementation device 120, the external project application device 110, the cloud-based project operations device 140, the one or more databases 150, and/or the user device 170. In some embodiments, the method 1000 comprises operations for identifying an external resource impact event and extracting an additional external resource object from the set of candidate external resource objects. In some embodiments, the example method 1000 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1000.

As shown in block 1002, the method 1000 may comprise identifying an external resource impact event associated with the first external resource object. As described above, in some embodiments, the cloud-based project operations device 140 is configured to identify an external resource impact event associated with a first external resource object. In some embodiments, the cloud-based project operations device 140 is configured to identify an external resource impact event associated with an external resource entity associated with an external resource object. In some embodiments, the one or more external resource implementation actions may be performed prior to identifying the external resource impact event. In some embodiments, an external resource impact event is any occurrence that causes a change to the capability of a first external resource entity to provide access to a physical component associated with a physical component object identified by the first project physical component record. In this regard, in some embodiments, a external resource impact event may comprise a change to a physical component object, an external resource feature, and/or the first project physical component record. In some embodiments, identifying an external resource impact event comprises the cloud-based project operations device 140 being configured to receive the external resource impact event from external project application device 110. In some embodiments, identifying an external resource impact event comprises the cloud-based project operations device 140 being configured to receive the external resource impact event from project foundation device 180.

As shown in block 1004, the method 1000 may comprise executing an external resource impact event computing script to extract an external resource impact event indicator from an external event source. As described above, in some embodiments, identifying an external resource impact event comprises execution, by the cloud-based project operations device 140, of one or more external resource impact event computing scripts. In some embodiments, the cloud-based project operations device 140 is configured to execute the one or more external resource impact event computing scripts using the inventory predictive computing entity 206. In some embodiments, execution of one or more external resource impact event computing scripts comprises executing code that causes a web scraper to extract an external resource impact event indicator from an external event source (e.g., an Internet source). In some embodiments, execution of one or more external resource impact event computing scripts comprises executing code that causes a web crawler to extract an external resource impact event indicator from an external event source. In some embodiments, execution of one or more external resource impact event computing scripts comprises executing code that causes monitoring of networked data packets to extract an external resource impact event indicator.

As shown in block 1006, the method 1000 may comprise extracting an additional external resource object from the set of candidate external resource objects by applying the physical component object, the external resource impact event, and the set of candidate external resource objects to the external resource prediction model. As described above, in some embodiments, the cloud-based project operations device 140 is configured to extract an additional external resource object from a set of candidate external resource objects. In some embodiments, the cloud-based project operations device 140 is configured to extract the additional external resource object from a set of candidate external resource objects using the inventory predictive computing entity 206. In some embodiments, the cloud-based project operations device 140 is configured to extract the additional external resource object from a set of candidate external resource objects by applying the physical component object, the external resource impact event, and/or the set of candidate external resource objects associated with the physical component object to an external resource prediction model.

As shown in block 1008, the method 1000 may comprise generating, using the external resource prediction model, an additional external resource prediction for the additional external resource object based on an additional external resource feature associated with the additional external resource object. As described above, in some embodiments, extracting the additional external resource object from a set of candidate external resource objects comprises the cloud-based project operations device 140 being configured to generate an additional external resource prediction for the additional external resource object. In some embodiments, the cloud-based project operations device 140 is configured to generate an additional external resource prediction for the additional external resource object using the external resource prediction model. In this regard, in some embodiments, the external resource prediction model may be configured to generate an additional external resource prediction for the additional external resource object using a similar process as described above with respect to generating the external resource prediction for the first external resource object. For example, an additional external resource prediction for the additional external resource object may be generated by the external resource prediction model based on an additional external resource feature associated with the additional external resource object

As shown in block 1010, the method 1000 may comprise generating, using the external resource prediction model, an additional entity prediction for the additional external resource object based on at least one of the additional external resource feature or an additional physical component record. As described above, in some embodiments, extracting the additional external resource object from a set of candidate external resource objects comprises the cloud-based project operations device 140 being configured to generate an additional project entity prediction. In some embodiments, the cloud-based project operations device 140 is configured to generate an additional project entity prediction for the additional external resource object using the external resource prediction model. In this regard, in some embodiments, the external resource prediction model may be configured to generate an additional project entity prediction for the additional external resource object using a similar process as described above with respect to generating the project entity prediction for the first external resource object. For example, an additional project entity prediction for the additional external resource object may be generated by the external resource prediction model based on at least one of an additional external resource feature or an additional physical component record.

As shown in block 1012, the method 1000 may comprise performing one or more external resource reconfiguration actions based on the additional external resource object. As described above, in some embodiments, the cloud-based project operations device 140 is configured to perform one or more external resource reconfiguration actions. For example, the cloud-based project operations device 140 is configured to perform one or more external resource reconfiguration actions using the project orchestration predictive computing entity 204. In some embodiments, the cloud-based project operations device 140 is configured to perform one or more external resource reconfiguration actions based on the additional external resource object. In some embodiments, the cloud-based project operations device 140 is configured to perform one or more external resource reconfiguration actions based on the additional external resource prediction. In some embodiments, the cloud-based project operations device 140 is configured to perform one or more external resource reconfiguration actions based on the additional project entity prediction. In this regard, for example, the cloud-based project operations device 140 may be configured to perform one or more external resource reconfiguration actions in order to execute, implement, and/or the like a plan, design, and/or process for implementing a project using an additional external resource object.

In some embodiments, performing one or more external resource reconfiguration actions comprises the cloud-based project operations device 140 being configured to generate an external resource reconfiguration interface component 602. In some embodiments, the external resource reconfiguration interface component 602 is configured to display a physical component object representation 404 that is representative of one or more physical component objects. For example, the physical component object representation 404 may be a representation of a physical component object for use by a plan for implementing the proposed project corresponding to a project physical component record. In some embodiments, the external resource reconfiguration interface component 602 is configured to display an additional external resource prediction representation 604 that is representative of an additional external resource prediction. For example, the additional external resource prediction representation 604 may be a representation of an additional external resource object associated with an additional external resource entity predicted to have a capability to provide access to a physical component associated with a physical component object identified by the project physical component record that further satisfies a threshold than the external resource entity due to the external resource impact event.

In some embodiments, performing one or more external resource reconfiguration actions comprises the cloud-based project operations device 140 being configured to cause an external resource reconfiguration interface component 602 to be rendered to external resource reconfiguration interface 600. In some embodiments, the external resource reconfiguration interface 600 may be provided on a display associated with the cloud-based project operations device 140 and/or a display associated with the project foundation device 180.

In some embodiments, performing one or more external resource reconfiguration actions comprises the cloud-based project operations device 140 being configured to execute one or more external resource reconfiguration computing scripts. In this regard, in some embodiments, the one or more external resource reconfiguration computing scripts comprise executable code configured to cause execution of at least a portion of a plan, design, and/or process for implementing a project. In some embodiments, execution of one or more external resource reconfiguration computing scripts comprises executing code that causes procurement of physical components and/or resources associated with a project physical component record. In some embodiments, execution of one or more external resource reconfiguration computing scripts comprises executing code that causes procurement of physical components and/or resources associated with a project physical component record from an additional external resource entity associated with an additional external resource object. In some embodiments, execution of one or more external resource reconfiguration computing scripts comprises executing code that causes actuation of a device that manufactures a physical component associated with a project physical component record (e.g., to turn on, create the physical component, and/or to shut down). In some embodiments, execution of one or more external resource reconfiguration computing scripts comprises executing code that causes a determination that an additional external resource prediction satisfies a threshold. In some embodiments, execution of one or more external resource reconfiguration computing scripts comprises executing code that causes a determination that an additional external resource prediction does not satisfy a threshold. In some embodiments, execution of one or more external resource reconfiguration computing scripts comprises executing code that causes a determination that an additional project entity prediction satisfies a threshold. In some embodiments, execution of one or more external resource reconfiguration computing scripts comprises executing code that causes a determination that an additional project entity prediction does not satisfy a threshold.

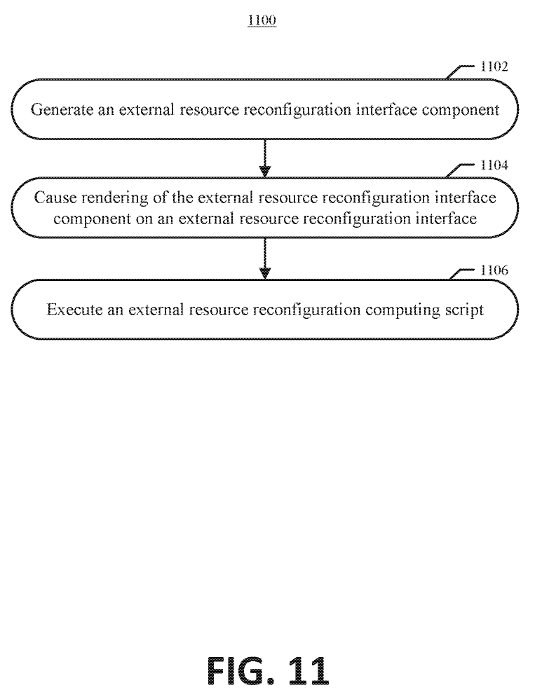

Referring now to FIG. 11, a flowchart providing an example method 1100 is illustrated. In this regard, FIG. 11 illustrates operations that may be performed by the project foundation device 180, the external project implementation device 120, the external project application device 110, the cloud-based project operations device 140, the one or more databases 150, and/or the user device 170. In some embodiments, the method 1100 comprises operations for performing the one or more external resource reconfiguration actions. In some embodiments, the example method 1100 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1100.

As shown in block 1102, the method 1100 may comprise generating an external resource reconfiguration interface component. In some embodiments, the external resource reconfiguration interface component comprises at least one of an additional external resource prediction representation or a physical component object representation. As described above, in some embodiments, performing one or more external resource reconfiguration actions comprises the cloud-based project operations device 140 being configured to generate an external resource reconfiguration interface component 602. In some embodiments, the external resource reconfiguration interface component 602 is configured to display a physical component object representation 404 that is representative of one or more physical component objects. For example, the physical component object representation 404 may be a representation of a physical component object for use by a plan for implementing the proposed project corresponding to a project physical component record. In some embodiments, the external resource reconfiguration interface component 602 is configured to display an additional external resource prediction representation 604 that is representative of an additional external resource prediction. For example, the additional external resource prediction representation 604 may be a representation of an additional external resource object associated with an additional external resource entity predicted to have a capability to provide access to a physical component associated with a physical component object identified by the project physical component record that further satisfies a threshold than the external resource entity due to the external resource impact event.

As shown in block 1104, the method 1100 may comprise causing rendering of the external resource reconfiguration interface component on an external resource reconfiguration interface. As described above, in some embodiments, performing one or more external resource reconfiguration actions comprises the cloud-based project operations device 140 being configured to cause an external resource reconfiguration interface component 602 to be rendered to external resource reconfiguration interface 600. In some embodiments, the external resource reconfiguration interface 600 may be provided on a display associated with the cloud-based project operations device 140 and/or a display associated with the project foundation device 180.

As shown in block 1106, the method 1100 may comprise executing an external resource reconfiguration computing script. As described above, in some embodiments, performing one or more external resource reconfiguration actions comprises the cloud-based project operations device 140 being configured to execute one or more external resource reconfiguration computing scripts. In this regard, in some embodiments, the one or more external resource reconfiguration computing scripts comprise executable code configured to cause execution of at least a portion of a plan, design, and/or process for implementing a project. In some embodiments, execution of one or more external resource reconfiguration computing scripts comprises executing code that causes procurement of physical components and/or resources associated with a project physical component record. In some embodiments, execution of one or more external resource reconfiguration computing scripts comprises executing code that causes procurement of physical components and/or resources associated with a project physical component record from an additional external resource entity associated with an additional external resource object. In some embodiments, execution of one or more external resource reconfiguration computing scripts comprises executing code that causes actuation of a device that manufactures a physical component associated with a project physical component record (e.g., to turn on, create the physical component, and/or to shut down). In some embodiments, execution of one or more external resource reconfiguration computing scripts comprises executing code that causes a determination that an additional external resource prediction satisfies a threshold. In some embodiments, execution of one or more external resource reconfiguration computing scripts comprises executing code that causes a determination that an additional external resource prediction does not satisfy a threshold. In some embodiments, execution of one or more external resource reconfiguration computing scripts comprises executing code that causes a determination that an additional project entity prediction satisfies a threshold. In some embodiments, execution of one or more external resource reconfiguration computing scripts comprises executing code that causes a determination that an additional project entity prediction does not satisfy a threshold.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
accessing, at a project orchestration predictive computing entity, a first project physical component record, wherein the first project physical component record comprises a physical component object;
retrieving, using an inventory predictive computing entity, a set of candidate external resource objects from an external resource object database based on the physical component object;
extracting, using the inventory predictive computing entity, a first external resource object from the set of candidate external resource objects by applying the physical component object and the set of candidate external resource objects to an external resource prediction model, wherein extracting the first external resource object from the set of candidate external resource objects comprises:
generating, using the external resource prediction model, an external resource prediction for the first external resource object based on an external resource feature associated with the first external resource object; and
performing, using the project orchestration predictive computing entity, one or more external resource implementation actions based on the first external resource object.

2. The method of claim 1, further comprising:
identifying a project execution indication corresponding to the first project physical component record; and
training the external resource prediction model based on the project execution indication and the first external resource object.

3. The method of claim 1, wherein extracting the first external resource object from the set of candidate external resource objects further comprises:
generating, using the external resource prediction model, a project entity prediction for the first external resource object based on at least one of the external resource feature or a secondary physical component record.

4. The method of claim 1, wherein performing the one or more external resource implementation actions comprises:
generating an external resource implementation interface component, wherein the external resource implementation interface component comprises at least one of an external resource prediction representation or a physical component object representation; and
causing rendering of the external resource implementation interface component on an external resource implementation interface.

5. The method of claim 1, wherein performing the one or more external resource implementation actions comprises:
executing an external resource implementation computing script.

6. The method of claim 1, further comprising:
identifying an external resource impact event associated with the first external resource object;
extracting an additional external resource object from the set of candidate external resource objects by applying the physical component object, the external resource impact event, and the set of candidate external resource objects to the external resource prediction model, wherein extracting the additional external resource object from the set of candidate external resource objects comprises:
generating, using the external resource prediction model, an additional external resource prediction for the additional external resource object based on an additional external resource feature associated with the additional external resource object; and
performing one or more external resource reconfiguration actions based on the additional external resource object.

7. The method of claim 6, wherein extracting the additional external resource object from the set of candidate external resource objects further comprises:
generating, using the external resource prediction model, an additional project entity prediction for the additional external resource object based on the additional external resource feature and an additional physical component record.

8. The method of claim 6, wherein identifying the external resource impact event comprises executing an external resource impact event computing script to extract an external resource impact event indicator from an external event source.

9. The method of claim 6, wherein performing the one or more external resource reconfiguration actions comprises:
generating an external resource reconfiguration interface component, wherein the external resource reconfiguration interface component comprises at least one of an additional external resource prediction representation or a physical component object representation; and
causing rendering of the external resource reconfiguration interface component on an external resource reconfiguration interface.

10. The method of claim 6, wherein performing the one or more external resource reconfiguration actions comprises:
executing an external resource reconfiguration computing script.

11. The method of claim 1, wherein the external resource feature comprises one or more of an external resource configuration feature, an external resource generation feature, an external resource volume feature, and external resource temporal feature, an external resource geographic feature, or an external resource impact feature.

12. An apparatus comprising memory and one or more processors communicatively coupled to the memory, the one or more processors configured to perform operations comprising:
accessing, at a project orchestration predictive computing entity, a first project physical component record, wherein the first project physical component record comprises a physical component object;
retrieving, using an inventory predictive computing entity, a set of candidate external resource objects from an external resource object database based on the physical component object;
extracting, using the inventory predictive computing entity, a first external resource object from the set of candidate external resource objects by applying the physical component object and the set of candidate external resource objects to an external resource prediction model, wherein extracting the first external resource object from the set of candidate external resource objects comprises:
generating, using the external resource prediction model, an external resource prediction for the first external resource object based on an external resource feature associated with the first external resource object; and
performing, using the project orchestration predictive computing entity, one or more external resource implementation actions based on the first external resource object.

13. The apparatus of claim 12, wherein extracting the first external resource object from the set of candidate external resource objects further comprises:
generating, using the external resource prediction model, a project entity prediction for the first external resource object based on at least one of the external resource feature or a secondary physical component record.

14. The apparatus of claim 12, wherein performing the one or more external resource implementation actions comprises:
generating an external resource implementation interface component, wherein the external resource implementation interface component comprises at least one of an external resource prediction representation or a physical component object representation; and
causing rendering of the external resource implementation interface component on an external resource implementation interface.

15. The apparatus of claim 12, wherein performing the one or more external resource implementation actions comprises:
executing an external resource implementation computing script.

16. The apparatus of claim 12, wherein the one or more processors are further configured to perform operations comprising:
identifying an external resource impact event associated with the first external resource object;
extracting an additional external resource object from the set of candidate external resource objects by applying the physical component object, the external resource impact event, and the set of candidate external resource objects to the external resource prediction model, wherein extracting the additional external resource object from the set of candidate external resource objects comprises:
generating, using the external resource prediction model, an additional external resource prediction for the additional external resource object based on an additional external resource feature associated with the additional external resource object; and
performing one or more external resource reconfiguration actions based on the additional external resource object.

17. The apparatus of claim 16, wherein extracting the additional external resource object from the set of candidate external resource objects further comprises:
generating, using the external resource prediction model, an additional project entity prediction for the additional external resource object based on at least one of the additional external resource feature or an additional physical component record.

18. The apparatus of claim 16, wherein identifying the external resource impact event comprises executing an external resource impact event computing script to extract an external resource impact event indicator from an external event source.

19. The apparatus of claim 16, wherein performing the one or more external resource reconfiguration actions comprises:
generating an external resource reconfiguration interface component, wherein the external resource reconfiguration interface component comprises at least one of an additional external resource prediction representation or a physical component object representation; and
causing rendering of the external resource reconfiguration interface component on an external resource reconfiguration interface.

20. A computer program product comprising at least one non-transitory computer-readable storage medium having computer program code stored thereon that, in execution with at least one processor, configures the computer program product for:
accessing, at a project orchestration predictive computing entity, a first project physical component record, wherein the first project physical component record comprises a physical component object;
retrieving, using an inventory predictive computing entity, a set of candidate external resource objects from an external resource object database based on the physical component object;
extracting, using the inventory predictive computing entity, a first external resource object from the set of candidate external resource objects by applying the physical component object and the set of candidate external resource objects to an external resource prediction model, wherein extracting the first external resource object from the set of candidate external resource objects comprises:
generating, using the external resource prediction model, an external resource prediction for the first external resource object based on an external resource feature associated with the first external resource object; and
performing, using the project orchestration predictive computing entity, one or more external resource implementation actions based on the first external resource object.
